(19) United States
(12) Patent Application Publication
(10) Pub. No.: US 2026/0347665 A1
(43) Pub. Date: Nov. 5, 2026

(54) PRESSURE-SENSITIVE ADHESIVE AGENT COMPOSITION AND PRESSURE-SENSITIVE ADHESIVE TAPE

(71) Applicant: Sekisui Chemical Co., Ltd., Osaka (JP)

(72) Inventors: Nagisa OGATA, Osaka (JP); Takayuki TANIMOTO, Osaka (JP); Yudai OGATA, Osaka (JP)

(73) Assignee: Sekisui Chemical Co., Ltd., Osaka (JP)

(21) Appl. No.: 19/125,378

(22) PCT Filed: Oct. 30, 2023
(86) PCT No.: PCT/JP2023/039132

§ 371 Date: Apr. 29, 2025

(30) Foreign Application Priority Data
Oct. 31, 2022 (JP) 2022-174515
Oct. 31, 2022 (JP) 2022-174516

(51) Int. Cl. C09J 7/38; C09J 7/10; C09J 11/08

(52) U.S. Cl. CPC C09J 7/385; C09J 7/10; C09J 11/08; C09J 2301/302; C09J 2301/408

(57) ABSTRACT

The present invention aims to provide an adhesive composition that can achieve both excellent adhesion and excellent optical transparency even when thinly applied. The present invention also aims to provide an adhesive tape including an adhesive layer containing the adhesive composition. Provided is an adhesive composition containing an acrylic copolymer containing a structural unit derived from an alkyl (meth)acrylate and a structural unit derived from an olefinic polymer having a polymerizable unsaturated double bond at an end, the adhesive composition satisfying at least one structure selected from the group consisting of the following first structure and the following second structure:
first structure: the adhesive composition contains at least one tackifier resin T1 selected from the group consisting of a terpene phenolic resin, a hydrogenated terpene phenolic resin, and a xylene resin,
the tackifier resin T1 is contained in an amount of 5 parts by mass or more and 50 parts by mass or less relative to 100 parts by mass of the acrylic copolymer, and
the adhesive composition does not contain a tackifier resin T2 different from a terpene phenolic resin, a hydrogenated terpene phenolic resin, and a xylene resin or contains the tackifier resin T2, and when the adhesive composition contains the tackifier resin T2, the tackifier resin T2 is contained in an amount of 10 parts by mass or less relative to 100 parts by mass of the acrylic copolymer; and
second structure: the acrylic copolymer contains a structural unit derived from a monomer containing a polar functional group,
the acrylic copolymer contains a structural unit derived from an alkyl (meth)acrylate in which an alkyl group bound to an oxygen atom of an ester bond has a carbon number of 1 to 4,
the structural unit derived from an alkyl (meth)acrylate in which an alkyl group bound to an oxygen atom of an ester bond has a carbon number of 1 to 4 is contained in an amount of 30% by mass or more and 90% by mass or less in the acrylic copolymer, and
the adhesive composition contains no tackifier resin or contains a tackifier resin, and when the adhesive composition contains a tackifier resin, the tackifier resin is contained in an amount of 5 parts by mass or less relative to 100 parts by mass of the acrylic copolymer.

### TECHNICAL FIELD

The present invention relates to an adhesive composition. The present invention also relates to an adhesive tape including an adhesive layer containing the adhesive composition.

### BACKGROUND ART

Adhesive tapes are used for assembling portable electronic equipment such as mobile phones and personal digital assistants (PDAs) (for example, Patent Literatures 1 and 2). Adhesive tapes are also used for bonding optical members (for example, Patent Literature 3).

### CITATION LIST

### Patent Literature

Patent Literature 1: JP 2009-242541 A
Patent Literature 2: JP 2009-258274 A
Patent Literature 3: JP 2012-214544 A

### SUMMARY OF INVENTION

### Technical Problem

Adhesive compositions and adhesive tapes used for bonding optical members require both adhesion and optical transparency. Particularly in recent years, as electronic equipment and devices have become smaller and thinner, there has been demand for thin application of adhesive compositions and thin adhesive tapes. However, thinly applied conventional adhesive compositions and thin adhesive tapes may not exhibit sufficient adhesion.

Conventional adhesive compositions and adhesive tapes contain tackifier resins for improved adhesion. However, adhesive compositions or adhesive tapes containing tackifier resins may become cloudy or yellow and fail to have optical transparency.

The present invention aims to provide an adhesive composition that can achieve both excellent adhesion and excellent optical transparency even when thinly applied. The present invention also aims to provide an adhesive tape including an adhesive layer containing the adhesive composition.

### Solution to Problem

The disclosure 1 relates to an adhesive composition containing an acrylic copolymer containing a structural unit derived from an alkyl (meth)acrylate and a structural unit derived from an olefinic polymer having a polymerizable unsaturated double bond at an end, the adhesive composition satisfying at least one structure selected from the group consisting of the following first structure and the following second structure:
first structure: the adhesive composition contains at least one tackifier resin T1 selected from the group consisting of a terpene phenolic resin, a hydrogenated terpene phenolic resin, and a xylene resin, the tackifier resin T1 is contained in an amount of 5 parts by mass or more and 50 parts by mass or less relative to 100 parts by mass of the acrylic copolymer, and the adhesive composition does not contain a tackifier resin T2 different from a terpene phenolic resin, a hydrogenated terpene phenolic resin, and a xylene resin or contains the tackifier resin T2, and when the adhesive composition contains the tackifier resin T2, the tackifier resin T2 is contained in an amount of 10 parts by mass or less relative to 100 parts by mass of the acrylic copolymer; and
second structure: the acrylic copolymer contains a structural unit derived from a monomer containing a polar functional group, the acrylic copolymer contains a structural unit derived from an alkyl (meth)acrylate in which an alkyl group bound to an oxygen atom of an ester bond in the alkyl (meth)acrylate has a carbon number of 1 to 4, the structural unit derived from an alkyl (meth)acrylate in which an alkyl group bound to an oxygen atom of an ester bond has a carbon number of 1 to 4 is contained in an amount of 30% by mass or more and 90% by mass or less in the acrylic copolymer, and the adhesive composition contains no tackifier resin or contains a tackifier resin, and when the adhesive composition contains a tackifier resin, the tackifier resin is contained in an amount of 5 parts by mass or less relative to 100 parts by mass of the acrylic copolymer.

The disclosure 2 relates to the adhesive composition according to the disclosure 1, wherein in the first structure, the acrylic copolymer contains a structural unit derived from a monomer containing a polar functional group.

The disclosure 3 relates to the adhesive composition according to the disclosure 1 or 2, wherein the structural unit derived from a monomer containing a polar functional group includes at least one structural unit selected from the group consisting of a structural unit derived from a carboxy group-containing monomer and a structural unit derived from a hydroxy group-containing monomer.

The disclosure 4 relates to the adhesive composition according to the disclosure 3, wherein the structural unit derived from a monomer containing a polar functional group includes the structural unit derived from a carboxy group-containing monomer.

The disclosure 5 relates to the adhesive composition according to the disclosure 4, wherein in the second structure, the structural unit derived from a carboxy group-containing monomer is contained in an amount of 10% by mass or less in the acrylic copolymer.

The disclosure 6 relates to the adhesive composition according to the disclosure 4 or 5, wherein the structural unit derived from a carboxy group-containing monomer is contained in an amount of 1% by mass or less in the acrylic copolymer.

The disclosure 7 relates to the adhesive composition according to the disclosure 3, 4, 5, or 6, wherein the structural unit derived from a monomer containing a polar functional group includes the structural unit derived from a hydroxy group-containing monomer.

The disclosure 8 relates to the adhesive composition according to the disclosure 1, 2, 3, 4, 5, 6, or 7, wherein in the first structure, the tackifier resin T1 includes the hydrogenated terpene phenolic resin.

The disclosure 9 relates to the adhesive composition according to the disclosure 1, 2, 3, 4, 5, 6, 7, or 8, wherein in the second structure, the acrylic copolymer contains a structural unit derived from an alkyl (meth)acrylate in which an alkyl group bound to an oxygen atom of an ester bond has a carbon number of 1 to 2, and the structural unit derived from an alkyl (meth)acrylate in which an alkyl group bound to an oxygen atom of an ester bond has a carbon number of 1 to 2 is contained in an amount of 10% by mass or more and 60% by mass or less in the acrylic copolymer.

The disclosure 10 relates to the adhesive composition according to the disclosure 1, 2, 3, 4, 5, 6, 7, 8, or 9, wherein in the second structure, the acrylic copolymer contains a structural unit derived from an alkyl (meth)acrylate in which an alkyl group bound to an oxygen atom of an ester bond has a carbon number of 3 to 4, and the structural unit derived from an alkyl (meth)acrylate in which an alkyl group bound to an oxygen atom of an ester bond has a carbon number of 3 to 4 is contained in an amount of 60% by mass or more in the acrylic copolymer.

The disclosure 11 relates to an adhesive tape including an adhesive layer containing the adhesive composition according to the disclosure 1, 2, 3, 4, 5, 6, 7, 8, 9, or 10.

The disclosure 12 relates to the adhesive tape according to the disclosure 11, wherein the adhesive layer has a gel fraction of 10% by mass or more and 80% by mass or less.

The disclosure 13 relates to the adhesive tape according to the disclosure 11 or 12, wherein the adhesive layer has a thickness of 15 μm or less.

The disclosure 14 relates to the adhesive tape according to the disclosure 13, which has a 180° peeling force for glass at 23 °C of 9 N/inch or higher after being attached and then left to stand at 23 °C for 24 hours.

The disclosure 15 relates to the adhesive tape according to the disclosure 11, 12, 13, or 14, which has a haze at 23 °C of 1.0% or lower.

The disclosure 16 relates to the adhesive tape according to the disclosure 11, 12, 13, 14, or 15, which includes no substrate.

The present invention is described in detail below.

Matters common to the first structure and the second structure are described without specifying which structure.

The present inventors considered the composition of the adhesive composition. The inventors made it contain an acrylic copolymer with a specific structure and considered the amount and type of tackifier resin to be contained in the adhesive composition. As a result, the inventors found out that it is possible to obtain an adhesive composition that can achieve both excellent adhesion and excellent optical transparency even when thinly applied. The invention was thus completed.

The adhesive composition of the present invention contains an acrylic copolymer containing a structural unit derived from an alkyl (meth)acrylate and a structural unit derived from an olefinic polymer having a polymerizable unsaturated double bond at an end.

The “(meth)acrylate” herein means acrylate or methacrylate.

The acrylic copolymer has a structure in which the structural units derived from an olefinic polymer having a polymerizable unsaturated double bond at an end interact and aggregate to form pseudo-crosslinking points. With the acrylic copolymer having such a structure, the adhesive composition under low strain exhibits a hard nature like a crosslinked adhesive composition and improved holding power. In contrast, under high strain due to peeling stress, as the pseudo-crosslinking points break and cause the molecules of the acrylic copolymer to stretch, the adhesive composition exhibits a highly flexible nature and improved adhesion. In other words, the adhesive composition containing the acrylic copolymer has improved adhesion and improved holding power.

Examples of the alkyl (meth)acrylate include alkyl (meth)acrylates obtained by dehydration-condensation of (meth)acrylic acid with an alcohol containing a linear or branched C1-C24 alkyl group. Specific examples thereof include methyl (meth)acrylate, ethyl (meth)acrylate, n-butyl (meth)acrylate, s-butyl (meth)acrylate, t-butyl (meth)acrylate, isobutyl (meth)acrylate, n-pentyl (meth)acrylate, isopentyl (meth)acrylate, n-hexyl (meth)acrylate, isohexyl (meth)acrylate, n-heptyl (meth)acrylate, isoheptyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, pentadecyl (meth)acrylate, hexadecyl (meth)acrylate, heptadecyl (meth)acrylate, stearyl (meth)acrylate, and isostearyl (meth)acrylate. Each of these alkyl (meth)acrylates may be used alone, or two or more of them may be used in combination.

The lower limit of the amount of the structural unit derived from an alkyl (meth)acrylate in the acrylic copolymer is preferably 50% by mass, and the upper limit thereof is preferably 95% by mass. When the amount of the structural unit derived from an alkyl (meth)acrylate is within the range, the adhesion and holding power of the adhesive composition can be further improved. The lower limit of the amount of the structural unit derived from an alkyl (meth)acrylate is more preferably 60% by mass, still more preferably 70% by mass, and the upper limit thereof is more preferably 90% by mass, still more preferably 85% by mass.

The olefinic polymer having a polymerizable unsaturated double bond at an end may have a polymerizable unsaturated double bond at one end or may have polymerizable unsaturated double bonds at both ends. Preferred is an olefinic polymer having a polymerizable unsaturated double bond at one end because such an olefinic polymer easily forms an appropriate number of pseudo-crosslinking points.

Examples of the olefinic polymer having a polymerizable unsaturated double bond at an end include ethylene-butylene copolymers, ethylene-propylene copolymers, ethylene polymers, propylene polymers, and butylene polymers that have at one or both ends a group having a polymerizable unsaturated double bond.

Each of these olefinic polymers having a polymerizable unsaturated double bond at an end may be used alone, or two or more of them may be used in combination.

Examples of the group having a polymerizable unsaturated double bond include a (meth)acryloyl group, a vinyl ether group, and a styryl group. Preferred among these is a (meth)acryloyl group because it has good copolymerizability with the alkyl (meth)acrylates.

Examples of the olefinic polymer having a (meth)acryloyl group at an end include ethylene macromonomers having a (meth)acryloyl group at one end, propylene macromonomers having a (meth)acryloyl group at one end, ethylene-butylene macromonomers having a (meth)acryloyl group at one end, and ethylene-propylene macromonomers having a (meth)acryloyl group at one end. Preferred among these are ethylene-butylene macromonomers having a (meth)acryloyl group at one end and ethylene-propylene macromonomers having a (meth)acryloyl group at one end, because they make it easy to adjust the later-described glass transition temperature to an appropriate range and can further improve the adhesion of the adhesive composition.

The “macromonomer” herein refers to a monomer having a weight average molecular weight of about 1,000 to 100,000 and having a polymerizable functional group.

The lower limit of the amount of the structural unit derived from an olefinic polymer having a polymerizable unsaturated double bond at an end in the acrylic copolymer is preferably 5% by mass, and the upper limit thereof is preferably 30% by mass. When the amount of the structural unit derived from an olefinic polymer having a polymerizable unsaturated double bond at an end is 5% by mass or more, the acrylic copolymer can form an appropriate number of pseudo-crosslinking points and further improve the adhesion and holding power of the adhesive composition. When the amount of the structural unit derived from an olefinic polymer having a polymerizable unsaturated double bond at an end is 30% by mass or less, cohesive failure of the adhesive composition can be further reduced. The lower limit of the amount of the structural unit derived from an olefinic polymer having a polymerizable unsaturated double bond at an end is more preferably 8% by mass, still more preferably 10% by mass, and the upper limit thereof is more preferably 27% by mass, still more preferably 25% by mass.

The adhesive composition of the present invention satisfies at least one structure selected from the group consisting of the following first structure and the second structure:
first structure: the adhesive composition contains at least one tackifier resin T1 selected from the group consisting of a terpene phenolic resin, a hydrogenated terpene phenolic resin, and a xylene resin, the tackifier resin T1 is contained in an amount of 5 parts by mass or more and 50 parts by mass or less relative to 100 parts by mass of the acrylic copolymer, and the adhesive composition does not contain a tackifier resin T2 different from a terpene phenolic resin, a hydrogenated terpene phenolic resin, and a xylene resin or contains the tackifier resin T2, and when the adhesive composition contains the tackifier resin T2, the tackifier resin T2 is contained in an amount of 10 parts by mass or less relative to 100 parts by mass of the acrylic copolymer; and
second structure: the acrylic copolymer contains a structural unit derived from a monomer containing a polar functional group, the acrylic copolymer contains a structural unit derived from an alkyl (meth)acrylate in which an alkyl group bound to an oxygen atom of an ester bond has a carbon number of 1 to 4, the structural unit derived from an alkyl (meth)acrylate in which an alkyl group bound to an oxygen atom of an ester bond has a carbon number of 1 to 4 is contained in an amount of 30% by mass or more and 90% by mass or less in the acrylic copolymer, and the adhesive composition contains no tackifier resin or contains a tackifier resin, and when the adhesive composition contains a tackifier resin, the tackifier resin is contained in an amount of 5 parts by mass or less relative to 100 parts by mass of the acrylic copolymer.

Satisfying at least one structure selected from the group consisting of the first structure and the second structure allows the adhesive composition of the present invention to achieve both excellent adhesion and excellent optical transparency even with a small thickness.

In the first structure, the acrylic copolymer preferably contains a structural unit derived from an alkyl (meth)acrylate in which an alkyl group bound to an oxygen atom of an ester bond has a carbon number of 1 to 8. In the case where the acrylic copolymer contains a structural unit derived from an alkyl (meth)acrylate in which an alkyl group bound to an oxygen atom of an ester bond has a carbon number of 1 to 4, the acrylic copolymer has higher polarity, which can further enhance the interaction of the acrylic copolymer with the adherend and thereby further improve the adhesion of the adhesive composition. In the case where the acrylic copolymer contains a structural unit derived from an alkyl (meth)acrylate in which an alkyl group bound to an oxygen atom of an ester bond has a carbon number of 4 to 8, the later-described glass transition temperature can be easily adjusted to an appropriate range, and the adhesion of the adhesive composition can be further improved.

Each of the structural units derived from an alkyl (meth)acrylate in which an alkyl group bound to an oxygen atom of an ester bond has a carbon number of 1 to 8 may be used alone, or two or more of them may be used in combination.

In the second structure, the acrylic copolymer preferably contains a structural unit derived from an alkyl (meth)acrylate in which an alkyl group bound to an oxygen atom of an ester bond has a carbon number of 1 to 4. When the acrylic copolymer contains a structural unit derived from an alkyl (meth)acrylate in which an alkyl group bound to an oxygen atom of an ester bond has a carbon number of 1 to 4, the acrylic copolymer has high polarity, which can enhance the interaction of the acrylic copolymer with the adherend and thereby improve the adhesion of the adhesive composition.

In the second structure, the lower limit of the amount of the structural unit derived from an alkyl (meth)acrylate in which an alkyl group bound to an oxygen atom of an ester bond has a carbon number of 1 to 4 in the acrylic copolymer is 30% by mass, and the upper limit thereof is 90% by mass. When the amount of the structural unit derived from an alkyl (meth)acrylate in which an alkyl group bound to an oxygen atom of an ester bond has a carbon number of 1 to 4 is 30% by mass or more, the acrylic copolymer has high polarity, which can enhance the interaction of the acrylic copolymer with the adherend and thereby improve the adhesion of the adhesive composition. When the amount of the structural unit derived from an alkyl (meth)acrylate in which an alkyl group bound to an oxygen atom of an ester bond has a carbon number of 1 to 4 is 90% by mass or less, the structural units derived from an olefinic polymer having a polymerizable unsaturated double bond at an end in the acrylic copolymer can form pseudo-crosslinking points that provide high cohesion. As a result, the adhesion and holding power of the adhesive composition can be improved. The lower limit of the amount of the structural unit derived from an alkyl (meth)acrylate in which an alkyl group bound to an oxygen atom of an ester bond has a carbon number of 1 to 4 is preferably 40% by mass, more preferably 50% by mass, and the upper limit thereof is preferably 85% by mass, more preferably 80% by mass.

Examples of the alkyl (meth)acrylate in which an alkyl group bound to an oxygen atom of an ester bond has a carbon number of 1 to 4 include alkyl (meth)acrylates obtained by dehydration-condensation of (meth)acrylic acid with an alcohol containing a linear or branched C1-C4 alkyl group. Specific examples include methyl (meth)acrylate, ethyl (meth)acrylate, n-butyl (meth)acrylate, s-butyl (meth)acrylate, t-butyl (meth)acrylate, and isobutyl (meth)acrylate.

In the second structure, from the viewpoint of the adhesion of the adhesive composition, the acrylic copolymer preferably contains a structural unit derived from an alkyl (meth)acrylate in which an alkyl group bound to an oxygen atom of an ester bond has a carbon number of 1 to 2. The lower limit of the amount of the structural unit derived from an alkyl (meth)acrylate in which an alkyl group bound to an oxygen atom of an ester bond has a carbon number of 1 to 2 in the acrylic copolymer is preferably 10% by mass, and the upper limit thereof is preferably 60% by mass. When the amount of the structural unit derived from an alkyl (meth)acrylate in which an alkyl group bound to an oxygen atom of an ester bond has a carbon number of 1 to 2 is 10% by mass or more, the acrylic copolymer has higher polarity, which can further enhance the interaction of the acrylic copolymer with the adherend and thereby further improve the adhesion of the adhesive composition. When the amount of the structural unit derived from an alkyl (meth)acrylate in which an alkyl group bound to an oxygen atom of an ester bond has a carbon number of 1 to 2 is 60% by mass or less, the later-described glass transition temperature of the acrylic copolymer can be easily adjusted to an appropriate range, and the adhesion of the adhesive composition can be further improved. The lower limit of the amount of the structural unit derived from an alkyl (meth)acrylate in which an alkyl group bound to an oxygen atom of an ester bond has a carbon number of 1 to 2 is more preferably 15% by mass, still more preferably 30% by mass.

In the second structure, from the viewpoint of the optical transparency of the adhesive composition, the acrylic copolymer preferably contains a structural unit derived from an alkyl (meth)acrylate in which an alkyl group bound to an oxygen atom of an ester bond has a carbon number of 3 to 4. The lower limit of the amount of the structural unit derived from an alkyl (meth)acrylate in which an alkyl group bound to an oxygen atom of an ester bond has a carbon number of 3 to 4 in the acrylic copolymer is preferably 60% by mass. When the amount of the structural unit derived from an alkyl (meth)acrylate in which an alkyl group bound to an oxygen atom of an ester bond has a carbon number of 3 to 4 is 60% by mass or more, the pseudo-crosslinking points formed by aggregation of the structural units derived from an olefinic polymer having a polymerizable unsaturated double bond at an end can be smaller, which can further improve the optical transparency of the adhesive composition. The lower limit of the amount of the structural unit derived from an alkyl (meth)acrylate in which an alkyl group bound to an oxygen atom of an ester bond has a carbon number of 3 to 4 is more preferably 70% by mass, still more preferably 75% by mass.

The upper limit of the amount of the structural unit derived from an alkyl (meth)acrylate in which an alkyl group bound to an oxygen atom of an ester bond has a carbon number of 3 to 4 is preferably 90% by mass. When the amount of the structural unit derived from an alkyl (meth)acrylate in which an alkyl group bound to an oxygen atom of an ester bond has a carbon number of 3 to 4 is 90% by mass or less, the adhesion can be further improved. The upper limit of the amount of the structural unit derived from an alkyl (meth)acrylate in which an alkyl group bound to an oxygen atom of an ester bond has a carbon number of 3 to 4 is more preferably 85% by mass, still more preferably 80% by mass.

In the second structure, each of the structural units derived from an alkyl (meth)acrylate in which an alkyl group bound to an oxygen atom of an ester bond has a carbon number of 1 to 4 may be used alone, or two or more of them may be used in combination. Particularly preferred is a combination use of the structural unit derived from an alkyl (meth)acrylate in which an alkyl group bound to an oxygen atom of an ester bond has a carbon number of 3 to 4 and the structural unit derived from an alkyl (meth)acrylate in which an alkyl group bound to an oxygen atom of an ester bond has a carbon number of 1 to 2. With the use of the structural unit derived from an alkyl (meth)acrylate in which an alkyl group bound to an oxygen atom of an ester bond has a carbon number of 3 to 4, the later-described glass transition temperature of the acrylic copolymer can be easily adjusted to an appropriate range, and the adhesion of the adhesive composition can be further improved. With the use of the structural unit derived from an alkyl (meth)acrylate in which an alkyl group bound to an oxygen atom of an ester bond has a carbon number of 1 to 2, the acrylic copolymer has higher polarity, which can further enhance the interaction of the acrylic copolymer with the adherend and thereby further improve the adhesion of the adhesive composition. In other words, the adhesion of the adhesive composition can be further improved by a combination use of the structural unit derived from an alkyl (meth)acrylate in which an alkyl group bound to an oxygen atom of an ester bond has a carbon number of 3 to 4 and the structural unit derived from an alkyl (meth)acrylate in which an alkyl group bound to an oxygen atom of an ester bond has a carbon number of 1 to 2.

In the second structure, the acrylic copolymer contains a structural unit derived from a monomer containing a polar functional group. When the acrylic copolymer contains the structural unit derived from a monomer containing a polar functional group, the interaction of the acrylic copolymer with the adherend can be enhanced, and thus the adhesion and holding power of the adhesive composition can be improved. Moreover, in the case where the adhesive composition contains the later-described crosslinking agent, the acrylic copolymer crosslinks via the crosslinking agent, thereby improving the adhesion and holding power of the adhesive composition. Adjusting the degree of crosslinking at this time can adjust the later-described gel fraction of the adhesive layer to an appropriate range.

In the first structure, the acrylic copolymer preferably contains a structural unit derived from a monomer containing a polar functional group. When the acrylic copolymer contains the structural unit derived from a monomer containing a polar functional group, the interaction of the acrylic copolymer with the adherend can be further enhanced, and thus the adhesion and holding power of the adhesive composition can be further improved. Moreover, in the case where the adhesive composition contains the later-described crosslinking agent, the acrylic copolymer crosslinks via the crosslinking agent, thereby improving the adhesion and holding power of the adhesive composition. Adjusting the degree of crosslinking at this time can adjust the later-described gel fraction of the adhesive layer to an appropriate range.

Examples of the monomer containing a polar functional group include a carboxy group-containing monomer, a hydroxy group-containing monomer, an amide group-containing monomer, and an amino group-containing monomer. In particular, to further improve the adhesion and holding power of the adhesive composition, the monomer containing a polar functional group preferably includes at least one selected from the group consisting of a carboxy group-containing monomer and a hydroxy group-containing monomer. In other words, the structural unit derived from a monomer containing a polar functional group preferably includes at least one structural unit selected from the group consisting of a structural unit derived from a carboxy group-containing monomer and a structural unit derived from a hydroxy group-containing monomer.

Each of these monomers containing a polar functional group may be used alone, or two or more of these may be used in combination.

When the acrylic copolymer contains the structural unit derived from a carboxy group-containing monomer, the interaction of the acrylic copolymer with the adherend can be further enhanced, and thus the adhesion and holding power of the adhesive composition can be further improved.

Examples of the carboxy group-containing monomer include unsaturated carboxylic acids such as (meth)acrylic acid, (meth)acryloylacetic acid, (meth)acryloylpropionic acid, (meth)acryloylbutyric acid, (meth)acryloylpentanoic acid, crotonic acid, maleic acid, fumaric acid, citraconic acid, mesaconic acid, and itaconic acid.

In the first structure, the upper limit of the amount of the structural unit derived from a carboxy group-containing monomer in the acrylic copolymer is preferably 1% by mass or less. When the amount of the structural unit derived from a carboxy group-containing monomer is 1% by mass or less, the adhesive composition can have lower metal corrosivity. The upper limit of the amount of the structural unit derived from a carboxy group-containing monomer is more preferably 0.5% by mass.

From the viewpoint of the metal corrosivity, the acrylic copolymer preferably does not contain the structural unit derived from a carboxy group-containing monomer.

In the second structure, the upper limit of the amount of the structural unit derived from a carboxy group-containing monomer in the acrylic copolymer is preferably 10% by mass or less. When the amount of the structural unit derived from a carboxy group-containing monomer is 10% by mass or less, the adhesive composition can have lower metal corrosivity. The upper limit of the amount of the structural unit derived from a carboxy group-containing monomer is more preferably 1% by mass.

From the viewpoint of the metal corrosivity, the acrylic copolymer preferably does not contain the structural unit derived from a carboxy group-containing monomer.

When the acrylic copolymer contains the structural unit derived from a hydroxy group-containing monomer, the acrylic copolymer can more easily crosslink with adherend molecules via a crosslinking agent, further improving the adhesion and holding power of the adhesive composition.

Examples of the hydroxy group-containing monomer include 4-hydroxybutyl (meth)acrylate and 2-hydroxyethyl (meth)acrylate.

The lower limit of the amount of the structural unit derived from a hydroxy group-containing monomer in the acrylic copolymer is preferably 0.01% by mass, and the upper limit thereof is preferably 2% by mass. When the amount of the structural unit derived from a hydroxy group-containing monomer is 0.01% by mass or more, the acrylic copolymer can more easily crosslink with adherend molecules via a crosslinking agent, further improving the adhesion and holding power of the adhesive composition. When the amount of the structural unit derived from a hydroxy group-containing monomer is 2% by mass or less, the acrylic copolymer is not excessively hard, and the adhesion of the adhesive composition can be further improved. The lower limit of the amount of the structural unit derived from a hydroxy group-containing monomer is more preferably 0.05% by mass, and the upper limit thereof is more preferably 1% by mass.

Examples of the amide group-containing monomer include N-vinyl-2-pyrrolidone, (meth)acrylamide, N,N-dimethyl(meth)acrylamide, and N-isopropyl(meth)acrylamide.

Examples of the amino group-containing monomer include (meth)acryloylmorpholine, 2-dimethylaminoethyl (meth)acrylate, and 2-diethylaminoethyl (meth)acrylate.

The lower limit of the total amount of the structural units derived from a monomer containing a polar functional group in the acrylic copolymer is preferably 0.1% by mass, and the upper limit thereof is preferably 10% by mass. When the total amount of the structural units derived from a monomer containing a polar functional group is 0.1% by mass or more, the interaction of the acrylic copolymer with the adherend can be further enhanced, and thus the adhesion and holding power of the adhesive composition can be further improved. Moreover, in the case where the adhesive composition contains the later-described crosslinking agent, the acrylic copolymer can more easily crosslink via the crosslinking agent, further improving the adhesion and holding power of the adhesive composition. When the total amount of the structural units derived from a monomer containing a polar functional group is 10% by mass or less, the acrylic copolymer is not excessively hard, and the adhesion of the adhesive composition can be further improved. The lower limit of the total amount of the structural units derived from a monomer containing a polar functional group is more preferably 1% by mass, still more preferably 3% by mass, and the upper limit thereof is more preferably 8% by mass, still more preferably 6% by mass.

The glass transition temperature (Tg) of the acrylic copolymer is preferably within the range of −100 °C or higher and 200 °C or lower. The upper limit thereof is more preferably −20 °C. When the glass transition temperature of the acrylic copolymer is −20 °C or lower, the molecules of the acrylic copolymer more easily stretch, which can further improve the adhesion of the adhesive composition. The upper limit of the glass transition temperature of the acrylic copolymer is still more preferably −30 °C, particularly preferably −35 °C. In the case where the adhesive composition contains multiple acrylic copolymers, preferably, all the acrylic copolymers contained in the adhesive composition have a glass transition temperature of −20 °C or lower.

The glass transition temperature of the acrylic copolymer can be measured by differential scanning calorimetry. More specifically, the glass transition temperature of the acrylic copolymer can be measured using, for example, a differential scanning calorimeter (e.g., available from Seiko Instruments Inc., “220C”) under a nitrogen atmosphere (nitrogen flow, flow rate 50 mL/min) by a method in conformity with JIS K6240:2011 at a measurement temperature from −100 °C to 200 °C and a temperature increase rate of 10 °C/min.

The glass transition temperature of the acrylic copolymer can be adjusted by adjusting the types and amounts of the monomers as materials of the acrylic copolymer.

The lower limit of the weight average molecular weight (Mw) of the acrylic copolymer is preferably 500,000, and the upper limit thereof is preferably 2,000,000. When the weight average molecular weight of the acrylic copolymer is 500,000 or greater, the adhesive composition can have high bulk cohesion and further improved adhesion and heat resistance. When the weight average molecular weight of the acrylic copolymer is 2,000,000 or less, the acrylic copolymer is not excessively hard, and the adhesion can be further improved. The lower limit of the weight average molecular weight of the acrylic copolymer is more preferably 650,000, and the upper limit thereof is more preferably 1,500,000.

The lower limit of the polydispersity of the acrylic copolymer is preferably 1.0, and the upper limit thereof is preferably 6.0. When the polydispersity of the acrylic copolymer is within the range, the adhesion and holding power of the adhesive composition can be further improved.

The lower limit of the polydispersity of the acrylic copolymer is more preferably 1.5, and the upper limit thereof is more preferably 4.5.

The polydispersity means the ratio (Mw/Mn) of the weight average molecular weight (Mw) to the number average molecular weight (Mn).

The weight average molecular weight, the number average molecular weight, and the polydispersity herein can be determined from the molecular weight distribution in terms of polystyrene measured by gel permeation chromatography (GPC). Specifically, for example, they can be determined by measurement using a gel permeation chromatograph (e.g., available from Waters, “2690 Separations Module”) under the following conditions.
Solvent: tetrahydrofuran
Sample flow rate: 1 mL/min
Detector: refractive index detector RI
Column: GPC KF-806L (available from Showa Denko K.K.)
Column temperature (measurement temperature): 40 °C
Injection volume: 20 μL

The amount of the acrylic copolymer in the adhesive composition is not limited. Preferably, the amount is more than 50% by mass in the adhesive composition (i.e., the acrylic copolymer is a main component of the adhesive composition). When the amount of the acrylic copolymer is more than 50% by mass, the adhesive composition can be more transparent and have further improved optical transparency.

In the first structure, the adhesive composition of the present invention contains a tackifier resin T1.

The tackifier resin T1 is at least one tackifier resin selected from the group consisting of a terpene phenolic resin, a hydrogenated terpene phenolic resin, and a xylene resin,

The tackifier resin T1, having a relatively high polarity and good compatibility with the acrylic copolymer, is easily taken inside the acrylic copolymer. As a result, the tackifier resin is less likely to inhibit the formation of pseudo-crosslinking points by the interaction between the low-polarity structural units derived from an olefinic polymer having a polymerizable unsaturated double bond at an end. Thus, the adhesion of the adhesive composition can be improved while the excellent adhesion of the acrylic copolymer is maintained. Moreover, since the tackifier resin T1 is easily taken inside the acrylic copolymer as noted above, the adhesive composition is less likely to become cloudy and have excellent optical transparency. Moreover, the tackifier resin T1 is resistant to oxidation because it has no polymerizable unsaturated double bond in its molecular structure. Thus, the tackifier resin T1 can reduce yellowing of the adhesive composition, and makes the adhesive composition less likely to lose its optical transparency even after long use.

Each of the tackifier resins T1 may be used alone, or two or more of them may be used in combination.

The tackifier resin T1 preferably includes at least one selected from the group consisting of a terpene phenolic resin and a hydrogenated terpene phenolic resin. When the tackifier resin T1 includes at least one selected from the group consisting of a terpene phenolic resin and a hydrogenated terpene phenolic resin, the tackifier resin T1 contains a hydroxy group, which can further enhance the interaction of the acrylic copolymer with the adherend and thereby further improve the adhesion of the adhesive composition.

More preferred among them is the hydrogenated terpene phenolic resin, which has a pale color and provides excellent optical transparency.

The terpene phenolic resin is a resin obtained by polymerizing a terpene compound in the presence of a phenol compound.

Examples of the phenol compound include phenol, cresol, xylenol, propyl phenol, nonyl phenol, methoxy phenol, bromophenol, bisphenol A, bisphenol F, bisphenol S, dihydroxynaphthalene, resorcinol, pyrocatechol, hydroquinone, pyrogallol, 1,2,4-trihydroxybenzene, and phloroglucinol.

Examples of the terpene compound include α-pinene, β-pinene, limonene, dipentene, δ-3-carene, dimethyl octatriene, allo-ocimene, myrcene, ocimene, linalool, and cosmene.

The terpene phenolic resin may further contain a different compound polymerized therein.

Each of the phenol compounds, terpene compounds, and different compounds may be used alone, or two or more of them may be used in combination.

The terpene phenolic resin may be a commercial product. An example of a commercial product is YS Polyster G150 (available from Yasuhara Chemical Co., Ltd.).

The hydrogenated terpene phenolic resin is a resin obtained by reducing the unsaturated bonds in the terpene phenolic resin into unsaturated bonds by hydrogenation. For example, a benzene ring in the terpene phenolic resin is converted into a cyclohexane ring by hydrogenation.

The hydrogenation of the terpene phenolic resin may be performed by the following method, for example.

Specifically, the terpene phenolic resin is dissolved in refined and dried cyclohexane to a polymer concentration of 5% by mass. Then, hydrogenation reaction is started with stirring at a hydrogen gas supply pressure of 0.7 MPa-Gauge and a reaction temperature of 80 °C. When the absorption of hydrogen ends, the reaction solution is returned to normal temperature and normal pressure and extracted from the reaction vessel. Thus, the hydrogenated terpene phenolic resin can be obtained.

The hydrogenated terpene phenolic resin may be a commercial product. An example of a commercial product is YS Polyster UH115 (available from Yasuhara Chemical Co., Ltd.).

The xylene resin is a resin obtained by reacting and polymerizing m-xylene and formaldehyde in the presence of an acid catalyst.

The xylene resin may further contain a different compound polymerized therein. Among different compounds, a phenol compound is preferably polymerized in the xylene resin. The phenol compound polymerized in the xylene resin allows the tackifier resin T1 to have higher polarity and better compatibility with the acrylic copolymer, which can further improve the adhesion of the adhesive composition.

The phenol compound polymerized in the xylene resin may be the same as that polymerized in the terpene phenolic resin.

Each of the different compounds may be used alone, or two or more of them may be used in combination.

The xylene resin may be a commercial product. An example of a commercial product is GHP-150 (available from Fudow Co., Ltd.)

The lower limit of the amount of the tackifier resin T1 is 5 parts by mass, and the upper limit thereof is 50 parts by mass, relative to 100 parts by mass of the acrylic copolymer. When the amount of the tackifier resin T1 is 5 parts by mass or more, the adhesive composition can have improved adhesion. When the amount of the tackifier resin T1 is 50 parts by mass or less, the adhesive composition is not excessively hard and can have improved adhesion. The lower limit of the amount of the tackifier resin T1 is preferably 10 parts by mass, more preferably 15 parts by mass, and the upper limit thereof is preferably 45 parts by mass, more preferably 40 parts by mass.

In the first structure, the adhesive composition of the present invention does not contain a tackifier resin T2 different from a terpene phenolic resin, a hydrogenated terpene phenolic resin, and a xylene resin or contains the tackifier resin T2, and when the adhesive composition contains the tackifier resin T2, the upper limit of the amount of the tackifier resin T2 is 10 parts by mass relative to 100 parts by mass of the acrylic copolymer. With the adhesive composition of the present invention not containing the tackifier resin T2 or containing the tackifier resin T2 and with the amount of the tackifier resin T2 being 10 parts by mass or less when the adhesive composition contains the tackifier resin T2, the adhesive composition is less likely to become cloudy or yellow and can have excellent optical transparency. When the adhesive composition contains the tackifier resin T2, the upper limit of the amount of the tackifier resin T2 is preferably 5 parts by mass.

In the adhesive composition, the amount of the tackifier resin T1 is preferably greater than the amount of the tackifier resin T2. When the amount of the tackifier resin T1 is greater than the amount of the tackifier resin T2, the adhesive composition can have better optical transparency.

In the second structure, the adhesive composition of the present invention contains no tackifier resin or contains a tackifier resin, and when the adhesive composition contains a tackifier resin, the upper limit of the amount of the tackifier resin is 5 parts by mass relative to 100 parts by mass of the acrylic copolymer. With the adhesive composition of the present invention not containing the tackifier resin or containing a tackifier resin and with the amount of the tackifier resin being 5 parts by mass or less when the adhesive composition contains the tackifier resin, the adhesive composition is even less likely to become cloudy or yellow and can have excellent optical transparency. When the adhesive composition contains a tackifier resin, the upper limit of the amount of the tackifier resin is preferably 4 parts by mass.

In the second structure, when the adhesive composition contains a tackifier resin, examples thereof include a terpene phenolic resin, a hydrogenated terpene phenolic resin, and a xylene resin. Preferred among these is a hydrogenated terpene phenolic resin, which has a pale color and provides excellent optical transparency.

The adhesive composition preferably contains a crosslinking agent. When the adhesive layer contains a crosslinking agent, the acrylic copolymer crosslinks via the crosslinking agent. Adjusting the degree of crosslinking at this time can adjust the later-described gel fraction of the adhesive layer to an appropriate range. For the acrylic copolymer to crosslink via the crosslinking agent, the acrylic copolymer preferably contains the structural unit derived from a monomer containing a polar functional group.

Examples of the crosslinking agent include epoxy crosslinking agents and isocyanate crosslinking agents. Preferred among these are isocyanate crosslinking agents because they make it easy to adjust the later-described gel fraction of the adhesive layer to an appropriate range and can further improve the adhesion and holding power of the adhesive tape including the adhesive layer.

The lower limit of the amount of the crosslinking agent is preferably 0.05 parts by mass, and the upper limit thereof is preferably 5 parts by mass, relative to 100 parts by mass of the acrylic copolymer. The crosslinking agent in an amount within the range makes it easy to adjust the later-described gel fraction of the adhesive layer to an appropriate range and can further improve the adhesion and holding power of the adhesive tape including the adhesive layer. The lower limit of the amount of the crosslinking agent is more preferably 0.1 parts by mass, and the upper limit thereof is more preferably 3 parts by mass.

The adhesive composition may contain conventionally known fine particles or additives such as inorganic fine particles, conductive fine particles, antioxidants, foaming agents, organic fillers, or inorganic fillers, if necessary.

The present invention encompasses an adhesive tape including an adhesive layer containing the adhesive composition of the present invention.

The adhesive tape of the present invention includes the adhesive layer containing the adhesive composition, and thus can have both excellent adhesion and excellent optical transparency even with a small thickness.

The lower limit of the gel fraction of the adhesive layer is preferably 10% by mass, and the upper limit thereof is preferably 80% by mass. When the adhesive layer has a gel fraction of 10% by mass or more, the adhesive layer is hard and can further improve the holding power of the adhesive tape. Moreover, the adhesive layer can have higher bulk cohesion and can further improve the heat resistance of the adhesive tape. When the gel fraction of the adhesive layer is 80% by mass or less, the adhesive layer can more easily stretch and further improve the adhesion of the adhesive tape. The lower limit of the gel fraction of the adhesive layer is more preferably 15% by mass, and the upper limit thereof is more preferably 75% by mass.

The gel fraction of the adhesive layer can be measured by the following method.

Specifically, W₀ (g) of the adhesive layer is sampled, immersed in 50 ml of tetrahydrofuran, and shaken with a shaker at 23 °C at 200 rpm for 24 hours. After shaking, a metal mesh (opening #200 mesh, mass: W₁ (g)) is used for filtration to separate the adhesive layer swollen with tetrahydrofuran. The separated adhesive layer is dried at 110 °C for one hour, and then the mass W₂ (g) of the adhesive layer including the metal mesh is measured. Using the obtained W₀, W₁, and W₂, the gel fraction is calculated from the following equation (1).

Gel fraction (% by mass)=100×(W₂−W₁)/W₀ (1)

(W₀: the initial mass of the adhesive layer, W₁: the initial mass of the metal mesh, W₂: the mass of the adhesive layer including metal mesh after drying)

The upper limit of the thickness of the adhesive layer is preferably 15 μm. When the thickness of the adhesive layer is 15 μm or less, the adhesive tape can be more suitably used to fix small or thin electronic equipment, for example. The upper limit of the thickness of the adhesive layer is more preferably 10 μm, still more preferably 5 μm.

There is no particular preferable lower limit of the thickness of the adhesive layer, but from the viewpoint of the handleability of the adhesive tape, the lower limit is about 2 μm.

The adhesive tape may be a non-supported tape including no substrate, or may be a supported tape including a substrate and the adhesive layer formed thereon. The adhesive tape is preferably a non-supported tape including no substrate. With no substrate, the adhesive tape can be thinner and also have better optical transparency. Such an adhesive tape can be more suitably used to fix small or thin electronic equipment or devices, for example.

In the case where the adhesive tape includes a substrate, the adhesive tape may be a one-sided adhesive tape including the adhesive layer on one side of the substrate, or may be a double-sided adhesive tape including the adhesive layer on each of the two sides of the substrate.

Examples of the substrate include sheets made of resins such as acrylic, olefin, polycarbonate, vinyl chloride, ABS, polyethylene terephthalate (PET), nylon, urethane, and polyimide, sheets having a mesh-like structure, and porous sheets.

The lower limit of the thickness of the substrate is preferably 5 μm, and the upper limit thereof is preferably 10 μm. When the thickness of the substrate is 5 μm or greater, the adhesive tape can have appropriate stiffness and thus excellent handleability. When the thickness of the substrate is 10 μm or less, the adhesive tape can be more suitably used to fix small or thin electronic equipment or devices, for example.

The upper limit of the haze at 23 °C of the substrate is preferably 0.5%. When the haze at 23 °C of the substrate is 0.5% or lower, the adhesive tape can have better optical transparency. The upper limit of the haze at 23 °C of the substrate is more preferably 0.3%.

There is no particular preferable lower limit of the haze at 23 °C of the substrate, but from the viewpoint of the optical transparency of the adhesive tape, the lower limit is preferably as close to 0% as possible.

The haze of the substrate can be measured using a haze meter (e.g., available from Nippon Denshoku Industries Co., Ltd., “NDH4000”), for example.

The adhesive tape may further contain a different layer as long as the effects of the present invention are not impaired.

The method for producing the adhesive tape is not limited and may be a conventionally known method. For example, first, the alkyl (meth)acrylate, the olefinic polymer having a polymerizable unsaturated double bond at an end, and an optional component such as a polar functional group monomer are copolymerized by a conventional method to give the acrylic copolymer. Next, the obtained acrylic copolymer is mixed with a tackifier resin such as the tackifier resin T1 and the tackifier resin T2 and other additive(s) if necessary to give an adhesive composition solution, and the adhesive composition solution is applied to a release-treated film and dried, whereby the adhesive tape can be produced. Alternatively, the adhesive tape produced by the method above may be used as an adhesive layer and bonded to a substrate to provide a supported adhesive tape.

In the case where the thickness of the adhesive layer is 15 μm or less, the lower limit of the 180° peeling force for glass at 23 °C of the adhesive tape after being attached and then left to stand at 23 °C for 24 hours is preferably 9 N/inch. When the 180° peeling force for glass at 23 °C of the adhesive layer after being attached and then left to stand at 23 °C for 24 hours is 9 N/inch or higher, the adhesive tape can be more suitably used to fix small or thin electronic equipment, for example. The lower limit of the 180° peeling force for glass at 23 °C of the adhesive tape after being attached and then left to stand at 23 °C for 24 hours is more preferably 10 N/inch.

There is no particular preferable upper limit of the 180° peeling force for glass at 23 °C of the adhesive tape after being attached and then left to stand at 23 °C for 24 hours.

The 180° peeling force for glass at 23 °C of the adhesive tape after being attached and then left to stand at 23 °C for 24 hours can be measured using the following method, for example.

The adhesive tape including the adhesive layer is cut into a flat rectangular shape (25 mm wide×60 mm long) to prepare a specimen. The obtained specimen is attached to a glass plate (available from Matsunami Glass Ind., Ltd., “Large white glass slide with polished edges No. 2”) using a 2-kg hand roller. Subsequently, the specimen is left to stand at 23 °C for 24 hours, and the obtained measurement sample is then subjected to a 180° peel test using a tensile tester (e.g., available from A&D Company, Ltd., “RTI-1310”) in conformity with JIS Z0237:2009 at 23 °C and a tensile speed of 300 mm/min, whereby the 180° peeling force for glass at 23 °C of the adhesive tape after being attached and then left to stand at 23 °C for 24 hours can be measured.

The upper limit of the haze at 23 °C of the adhesive tape is preferably 1.0%. When the haze at 23 °C of the adhesive tape is 1.0% or lower, the adhesive tape can have better optical transparency. The upper limit of the haze at 23 °C of the adhesive tape is more preferably 0.5%, still more preferably 0.3%.

There is no particular preferable lower limit of the haze at 23 °C of the adhesive tape, but from the viewpoint of the optical transparency of the adhesive tape, the lower limit is preferably as close to 0% as possible.

The haze at 23 °C of the adhesive tape can be measured using the following method, for example.

The adhesive tape (thickness of the adhesive layer: 5 μm) is cut into a flat rectangular shape (40 mm×40 mm), then the polyethylene terephthalate film on one surface of the cut adhesive tape is removed, and the adhesive tape is attached to soda glass (0.7 mm×56 mm×86.6 mm) using a 2-kg hand roller. Subsequently, the polyethylene terephthalate film on the other surface of the attached adhesive tape is removed, and the haze is measured at normal temperature (23 °C) using a spectrophotometer (e.g., available from Konica Minolta, Inc., “CM-3700”) by evaluating light transmitted from the single-layer sheet side to the soda glass side in the SCI mode.

The upper limit of the yellowness index b* at 23 °C of the adhesive tape is preferably 0.4. When the yellowness index b* at 23 °C of the adhesive layer is 0.4 or lower, the adhesive tape can have better optical transparency. The upper limit of the yellowness index b* at 23 °C of the adhesive tape is more preferably 0.2.

The yellowness index b* at 23 °C of the adhesive tape can be measured using the following method.

Specifically, the adhesive tape (thickness of the adhesive layer: 15 μm) is cut into a flat rectangular shape (40 mm×40 mm), then the polyethylene terephthalate film on one surface of the cut adhesive tape is removed, and the adhesive tape is attached to soda glass (0.7 mm×56 mm×86.6 mm) using a 2-kg hand roller. Subsequently, the polyethylene terephthalate film on the other surface of the attached adhesive tape is removed, and the yellowness index b* is measured at normal temperature (23 °C) using a spectrophotometer (e.g., available from Konica Minolta, Inc., “CM-3700”) by evaluating light transmitted from the single-layer sheet side to the soda glass side in the SCI mode.

The upper limit of the yellowness index b* of the adhesive tape after being heated at 85 °C for 500 hours is preferably 0.4. When the yellowness index b* of the adhesive tape after being heated at 85 °C for 500 hours is 0.4 or lower, the adhesive tape can have better optical transparency. Moreover, the adhesive tape is less likely to lose its optical transparency even after long use. The upper limit of the yellowness index b* of the adhesive tape after being heated at 85 °C for 500 hours is more preferably 0.2.

The yellowness index b* of the adhesive tape after being heated at 85 °C for 500 hours can be measured using the following method, for example.

Specifically, the adhesive tape (thickness of the adhesive layer: 15 μm) is cut into a flat rectangular shape (40 mm×40 mm), and the cut adhesive tape is heated in an oven at 85 °C for 500 hours. The heated adhesive tape is then left to naturally cool to normal temperature (23 °C). The polyethylene terephthalate film on one surface is then removed, and the adhesive tape is attached to soda glass (0.7 mm×56 mm×86.6 mm) using a hand roller. Subsequently, the polyethylene terephthalate film on the other surface of the attached adhesive tape is removed, and the yellowness index b* is measured at normal temperature (23 °C) using a spectrophotometer (e.g., available from Konica Minolta, Inc., “CM-3700”) by evaluating light transmitted from the single-layer sheet side to the soda glass side in the SCI mode.

The adhesive tape of the present invention may be used in any application. Since the adhesive tape has excellent adhesion and excellent optical transparency, it can be suitably used in applications of bonding optical members such as electronic equipment and devices. In particular, the adhesive tape of the present invention can exhibit excellent adhesion and excellent optical transparency even with a thin adhesive layer, and thus can be more suitably used to fix small or thin electronic equipment or devices, for example.

### Advantageous Effects of Invention

The present invention can provide an adhesive composition that can achieve both excellent adhesion and excellent optical transparency even when thinly applied. The present invention can also provide an adhesive tape including an adhesive layer containing the adhesive composition.

### DESCRIPTION OF EMBODIMENTS

Embodiments of the present invention are more specifically described in the following with reference to examples. The present invention should not be limited to these examples.

### Synthesis of Acrylic Copolymers A to S

A reaction vessel equipped with a thermometer, a stirrer, and a condenser was charged with 300 mL of ethyl acetate and structural unit monomers shown in Table 1 or 2. The reaction vessel was then heated to initiate reflux. Subsequently, 0.01 parts by mass of 1,1-bis(t-hexylperoxy)-3,3,5-trimethylcyclohexane as a polymerization initiator was added to the reaction vessel to start polymerization under reflux. Then, 1,1-bis(t-hexylperoxy)-3,3,5-trimethylcyclohexane was added one hour after and two hours after the start of polymerization (0.01 parts by mass each time). Four hours after the start of polymerization, 0.05 parts by mass of t-hexyl peroxypivalate was added to continue the polymerization reaction. A total of eight hours of polymerization reaction was performed from the start of polymerization. In this manner, solutions of acrylic copolymers A to S in ethyl acetate were obtained. The ethylene-butylene macromonomer shown in Tables 1 and 2 was L-1253 (available from Kuraray Co., Ltd.).

The obtained acrylic copolymers were subjected to measurement of the molecular weight distribution in terms of polystyrene using a gel permeation chromatograph (GPC) (available from Waters Corporation, “2690 Separations Module”) under the conditions below. From the obtained molecular weight distribution curves, the weight average molecular weight (Mw), the number average molecular weight (Mn), and the polydispersity (Mw/Mn) of the acrylic copolymers were determined.

### <GPC Measurement Conditions>

Solvent: tetrahydrofuran
Sample flow rate: 1 mL/min
Detector: refractive index detector RI
Column: GPC KF-806L (available from Showa Denko K.K.)
Column temperature (measurement temperature): 40 °C
Injection volume: 20 μL

TABLE 1

| | | | | Acrylic copolymer | | | | |
|---|---|---|---|---|---|---|---|---|
| | | | | A | B | C | D | E |
| Structural | Alkyl (meth)acrylate | n-Butyl acrylate | | 73.9 | 80 | 36.95 | 39 | 38.85 |
| unit | | Methyl acrylate | | — | — | 36.95 | 39 | 38.85 |
| monomer | | 2-ethylhexyl acrylate | | — | — | — | — | — |
| (parts | | Cyclohexyl acrylate | | — | — | — | — | — |
| by mass) | Olefinic polymer having a | Ethylene-butylene macromonomer | | 20 | 20 | 20 | 20 | 20 |
| | polymerizable unsaturated | | | | | | | |
| | double bond at an end | | | | | | | |
| | Monomer containing polar | Carboxy group- | Acrylic acid | 6 | — | 6 | 1 | 0.3 |
| | functional group | containing | | | | | | |
| | | monomer | | | | | | |
| | | Hydroxy group- | 4-Hydroxybutyl | 0.1 | — | 0.1 | 1 | 2 |
| | | containing | acrylate | | | | | |
| | | monomer | | | | | | |

| | | | | | |
|---|---|---|---|---|---|
| Total parts (by mass) | 100 | 100 | 100 | 100 | 100 |
| Total parts (by mass) of alkyl (meth)acrylates in which an alkyl group bound | 73.9 | 80 | 36.95 | 39 | 38.85 |
| to an oxygen atom of an ester bond has a carbon number of 3 to 4 | | | | | |
| Total parts (by mass) of alkyl (meth)acrylates in which an alkyl group bound | — | — | 36.95 | 39 | 38.85 |
| to an oxygen atom of an ester bond has a carbon number of 1 to 2 | | | | | |
| Total parts (by mass) of alkyl (meth)acrylates in which an alkyl group bound | 73.9 | 80 | 73.9 | 78 | 77.7 |
| to an oxygen atom of an ester bond has a carbon number of 1 to 4 | | | | | |
| Weight average molecular weight (Mw) | 1,000,000 | 1,000,000 | 1,000,000 | 1,000,000 | 1,000,000 |
| Polydispersity (Mw/Mn) | 5 | 5 | 5 | 5 | 5 |

| | | | Acrylic copolymer | | | |
|---|---|---|---|---|---|---|
| | | | F | G | H | I |
| Structural | Alkyl (meth)acrylate | n-Butyl acrylate | 39 | 37 | 83.9 | 63.9 |
| unit | | Methyl acrylate | 39 | 37 | — | — |
| monomer | | 2-ethylhexyl acrylate | — | — | — | — |
| (parts | | Cyclohexyl acrylate | — | — | — | — |
| by mass) | Olefinic polymer having a | Ethylene-butylene macromonomer | 20 | 20 | 10 | 30 |
| | polymerizable unsaturated | | | | | |
| | double bond at an end | | | | | |

| | | | | | | |
|---|---|---|---|---|---|---|
| Monomer containing polar | Carboxy group- | Acrylic acid | — | 6 | 6 | 6 |
| functional group | containing | | | | | |
| | monomer | | | | | |
| | Hydroxy group- | 4-Hydroxybutyl | 2 | — | 0.1 | 0.1 |
| | containing | acrylate | | | | |
| | monomer | | | | | |

| | | | | |
|---|---|---|---|---|
| Total parts (by mass) | 100 | 100 | 100 | 100 |
| Total parts (by mass) of alkyl (meth)acrylates in which an alkyl group bound | 39 | 37 | 83.9 | 63.9 |
| to an oxygen atom of an ester bond has a carbon number of 3 to 4 | | | | |
| Total parts (by mass) of alkyl (meth)acrylates in which an alkyl group bound | 39 | 37 | — | — |
| to an oxygen atom of an ester bond has a carbon number of 1 to 2 | | | | |
| Total parts (by mass) of alkyl (meth)acrylates in which an alkyl group bound | 78 | 74 | 83.9 | 63.9 |
| to an oxygen atom of an ester bond has a carbon number of 1 to 4 | | | | |
| Weight average molecular weight (Mw) | 1,000,000 | 1,000,000 | 1,000,000 | 1,000,000 |
| Polydispersity (Mw/Mn) | 5 | 5 | 5 | 5 |

TABLE 2

| | | | | Acrylic copolymer | | | | |
|---|---|---|---|---|---|---|---|---|
| | | | | J | K | L | M | N |
| Structural | Alkyl | n-Butyl | | 79.9 | 71.9 | 59.1 | 19.4 | 15.5 |
| unit | (meth)acrylate | acrylate | | | | | | |
| monomer | | Methyl acrylate | | — | — | 14.8 | 58.3 | 62.2 |
| (parts | | 2-ethylhexyl acrylate | | — | — | — | — | — |
| by mass) | | Cyclohexyl acrylate | | — | — | — | — | — |
| | Olefinic | Ethylene-butylene | | 20 | 20 | 20 | 20 | 20 |
| | polymer | macromonomer | | | | | | |
| | having a | | | | | | | |
| | polymerizable | | | | | | | |
| | unsaturated | | | | | | | |
| | double bond | | | | | | | |
| | at an end | | | | | | | |
| | Monomer | Carboxy group- | Acrylic | — | 8 | 6 | 0.3 | 0.3 |
| | containing | containing | acid | | | | | |
| | polar | monomer | | | | | | |
| | functional | Hydroxy group- | 4-Hydroxybutyl | 0.1 | 0.1 | 0.1 | 2 | 2 |
| | group | containing | acrylate | | | | | |
| | | monomer | | | | | | |
| Total parts (by mass) | | | | 100 | 100 | 100 | 100 | 100 |
| Total parts (by mass) of alkyl | | | | 79.9 | 71.9 | 59.1 | 19.4 | 15.5 |
| (meth)acrylates in which | | | | | | | | |
| an alkyl group bound | | | | | | | | |
| to an oxygen atom of an ester | | | | | | | | |
| bond has a carbon number of 3 to 4 | | | | | | | | |
| Total parts (by mass) of alkyl | | | | — | — | 14.8 | 58.3 | 62.2 |
| (meth)acrylates in which | | | | | | | | |
| an alkyl group bound | | | | | | | | |
| to an oxygen atom of an ester | | | | | | | | |
| bond has a carbon number of 1 to 2 | | | | | | | | |
| Total parts (by mass) of alkyl | | | | 79.9 | 71.9 | 73.9 | 77.7 | 77.7 |
| (meth)acrylates in which | | | | | | | | |
| an alkyl group bound | | | | | | | | |
| to an oxygen atom of an ester | | | | | | | | |
| bond has a carbon number of 1 to 4 | | | | | | | | |
| Weight average molecular weight (Mw) | | | | 1,000,000 | 1,000,000 | 1,000,000 | 1,000,000 | 1,000,000 |
| Polydispersity (Mw/Mn) | | | | 5 | 5 | 5 | 5 | 5 |
| | | | | Acrylic copolymer | | | | |
| | | | | O | P | Q | R | S |
| Structural | Alkyl | n-Butyl | | 38.85 | 54.4 | 93.9 | 19.4 | 92.7 |
| unit | (meth)acrylate | acrylate | | | | | | |
| monomer | | Methyl acrylate | | — | — | — | — | — |
| (parts | | 2-ethylhexyl acrylate | | — | — | — | 58.3 | — |
| by mass) | | Cyclohexyl acrylate | | 38.85 | 23.3 | — | — | — |
| | Olefinic | Ethylene-butylene | | 20 | 20 | — | 20 | 5 |
| | polymer | macromonomer | | | | | | |
| | having a | | | | | | | |
| | polymerizable | | | | | | | |
| | unsaturated | | | | | | | |
| | double bond | | | | | | | |
| | at an end | | | | | | | |
| | Monomer | Carboxy group- | Acrylic | 0.3 | 0.3 | 6 | 0.3 | 0.3 |
| | containing | containing | acid | | | | | |
| | polar | monomer | | | | | | |
| | functional | Hydroxy group- | 4-Hydroxybutyl | 2 | 2 | 0.1 | 2 | 2 |
| | group | containing | acrylate | | | | | |
| | | monomer | | | | | | |

| | | | | | |
|---|---|---|---|---|---|
| Total parts (by mass) | 100 | 100 | 100 | 100 | 100 |
| Total parts (by mass) of alkyl | 38.85 | 54.4 | 93.9 | 19.4 | 92.7 |
| (meth)acrylates in which | | | | | |
| an alkyl group bound | | | | | |
| to an oxygen atom of an ester | | | | | |
| bond has a carbon number of 3 to 4 | | | | | |
| Total parts (by mass) of alkyl | — | — | — | — | — |
| (meth)acrylates in which | | | | | |
| an alkyl group bound | | | | | |
| to an oxygen atom of an ester | | | | | |
| bond has a carbon number of 1 to 2 | | | | | |
| Total parts (by mass) of alkyl | 38.85 | 54.4 | 93.9 | 19.4 | 92.7 |
| (meth)acrylates in which | | | | | |
| an alkyl group bound | | | | | |
| to an oxygen atom of an ester | | | | | |
| bond has a carbon number of 1 to 4 | | | | | |
| Weight average molecular weight (Mw) | 1,000,000 | 1,000,000 | 1,000,000 | 1,000,000 | 1,000,000 |
| Polydispersity (Mw/Mn) | 5 | 5 | 5 | 5 | 5 |

### Examples 1-1 to 1-28 and 2-1 to 2-19 and Comparative Examples 1 to 9

### (1) Preparation of Adhesive Composition

Materials were added to the solutions of acrylic copolymers A to S in ethyl acetate according to the compositions shown in Tables 3 to 8 and stirred, whereby adhesive compositions were obtained.

### (2) Production of Adhesive Tape

Polyethylene terephthalate film with one release-treated surface was provided. The adhesive compositions obtained in “(1) Preparation of adhesive composition” were each applied to the release-treated surface of the polyethylene terephthalate film to a desired dried film thickness and dried at 110 °C for five minutes, whereby laminated sheets, each having an adhesive layer with a desired thickness on the release-treated surface of the polyethylene terephthalate film, were produced. Subsequently, polyethylene terephthalate film with one release-treated surface was placed on the adhesive layer of each of the laminated sheets, whereby adhesive tapes each including an adhesive layer with a desired thickness were obtained.

### (3) Gel Fraction of Adhesive Layer

W₀ (g) of the adhesive layer was sampled from each of the obtained adhesive tapes, immersed in 50 ml of tetrahydrofuran, and shaken with a shaker at 23 °C at 200 rpm for 24 hours. After shaking, a metal mesh (opening #200 mesh, mass: W₁ (g)) was used for filtration to separate the adhesive layer swollen with tetrahydrofuran. The separated adhesive layer was dried at 110 °C for one hour, and then the mass W₂ (g) of the adhesive layer including the metal mesh was measured. Using the obtained W₀, W₁, and W₂, the gel fraction of the adhesive layer was calculated from the following equation (1). Tables 3 to 8 show the results.

Gel fraction (% by mass)=100×(W₂−W₁)/W₀ (1)

(W₀: the initial mass of the adhesive layer, W₁: the initial mass of the metal mesh, W₂: the mass of the adhesive layer including metal mesh after drying)

### <Evaluation>

The adhesive tapes obtained in the examples and the comparative examples were evaluated as follows. Tables 3 to 8 show the results.

### (Adhesion)

An adhesive tape including an adhesive layer with a thickness of 15 μm was produced using the method of “(2) Production of adhesive tape”, and the obtained adhesive tape was then cut into a flat rectangular shape (25 mm wide×60 mm long) to prepare a specimen. The obtained specimen was then attached to a glass plate (available from Matsunami Glass Ind., Ltd., “Large white glass slide with polished edges No. 2”) by moving a 2-kg hand roller back and forth once at a speed of 300 mm/min. Subsequently, the specimen was left to stand at 23 °C for 24 hours, and then a 180° peel test was performed on the obtained measurement sample using a tensile tester (available from A&D Company, Ltd., “RTI-1310”) in conformity with JIS Z0237:2009 at 23 °C and a tensile speed of 300 mm/min, whereby the 180° peeling force for glass at 23 °C of the adhesive tape after being attached and then left to stand at 23 °C for 24 hours was measured.

The adhesion of the adhesive tape was evaluated as “oo” (Excellent) when the obtained 180° peeling force for glass at 23 °C of the adhesive tape after being attached and then left to stand at 23 °C for 24 hours was 10 N/inch or higher, “∘” (Good) when the 180° peeling force was 9 N/inch or higher and lower than 10 N/inch, “Δ” (Fair) when the 180° peeling force was 8 N/inch or higher and lower than 9 N/inch, and “x” (Poor) when the 180° peeling force was lower than 8 N/inch.

Also for an adhesive tape including an adhesive layer with a thickness of 5 μm, the 180° peeling force for glass at 23 °C of the adhesive tape after being attached and then left to stand at 23 °C for 24 hours was measured, and the adhesion of the adhesive tape was evaluated in the same manner.

### (Optical Transparency)

### (1) Haze at 23 °C

An adhesive tape including an adhesive layer with a thickness of 5 μm was produced using the method of “(2) Production of adhesive tape”, and the obtained adhesive tape was then cut into a flat rectangular shape (40 mm×40 mm). The polyethylene terephthalate film on one surface of the cut adhesive tape was removed, and the adhesive tape was attached to soda glass (0.7×56×86.6 mm) by moving a 2-kg hand roller back and forth once at a speed of 300 mm/min. Subsequently, the polyethylene terephthalate film on the other surface of the attached adhesive tape was removed, and the haze at 23 °C of the adhesive tape was measured at normal temperature (23 °C) using a spectrophotometer (available from Konica Minolta, Inc., “CM-3700”) by evaluating light transmitted from the single-layer sheet side to the soda glass side in the SCI mode.

The optical transparency of the adhesive tape was evaluated as “oo” (Excellent) when the obtained haze at 23 °C was 0.5% or lower, “∘” (Good) when the haze was higher than 0.5% and 1.0 or lower, “Δ” (Fair) when the haze was higher than 1.0% and 1.5% or lower, and “x” (Poor) when the haze was higher than 1.5%.

### (2) Yellowness Index b* at 23 °C

An adhesive tape including an adhesive layer with a thickness of 15 μm was produced using the method of “(2) Production of adhesive tape”, and the obtained adhesive tape was then cut into a flat rectangular shape (40 mm×40 mm). The polyethylene terephthalate film on one surface of the cut adhesive tape was removed, and the adhesive tape was attached to soda glass (0.7×56×86.6 mm) by moving a 2-kg hand roller back and forth once at a speed of 300 mm/min. Subsequently, the polyethylene terephthalate film on the other surface of the attached adhesive tape was removed, and the yellowness index b* at 23 °C of the adhesive layer was measured at normal temperature (23 °C) using a spectrophotometer (available from Konica Minolta, Inc., “CM-3700”) by evaluating light transmitted from the single layer sheet side to the soda glass side in the SCI mode.

The optical transparency of the adhesive tape was evaluated as “oo” (Excellent) when the obtained yellowness index b* at 23 °C was 0.2 or lower, “∘” (Good) when the yellowness index b* was higher than 0.2 and 0.4 or lower, “Δ” (Fair) when the yellowness index b* was higher than 0.4 and 0.5 or lower, and “x” (Poor) when the yellowness index b* was higher than 0.5.

(3) Yellowness Index b* after being Heated at 85 °C for 500 Hours

An adhesive tape including an adhesive layer with a thickness of 15 μm was produced using the method of “(2) Production of adhesive tape”, and the obtained adhesive tape was then cut into a flat rectangular shape (40 mm×40 mm). The cut adhesive tape was heated in an oven at 85 °C for 500 hours. The heated adhesive tape was then left to naturally cool to normal temperature (23 °C). The polyethylene terephthalate film on one surface of the cut adhesive tape was then removed, and the adhesive tape was attached to soda glass (0.7×56×86.6 mm) by moving a 2-kg hand roller back and forth once at a speed of 300 mm/min. Subsequently, the polyethylene terephthalate film on the other surface of the attached adhesive tape was removed, and the yellowness index b* of the adhesive tape after being heated at 85 °C for 500 hours was measured at normal temperature (23 °C) using a spectrophotometer (available from Konica Minolta, Inc., “CM-3700”) by evaluating light transmitted from the single layer sheet side to the soda glass side in the SCI mode.

The optical transparency of the adhesive tape was evaluated as “oo” (Excellent) when the obtained yellowness index b* after being heated at 85 °C for 500 hours was 0.2 or lower, “∘” (Good) when the yellowness index b* was higher than 0.2 and 0.4 or lower, “Δ” (Fair) when the yellowness index b* was higher than 0.4 and 0.5 or lower, and “x” (Poor) when the yellowness index b* was higher than 0.5.

### (Metal Corrosivity)

After the 180⁰ peel test in the evaluation of “(Adhesion)” on the adhesive tape including an adhesive layer with a thickness of 15 μm, the surface of the SUS plate after peeling off the adhesive tape was visually observed.

The metal corrosivity of the adhesive composition was evaluated as “∘” (Good) when no corrosion was found on the surface of the SUS plate, and “x” (Poor) when corrosion was found on the surface of the SUS plate.

Even if evaluated as “x” (Poor) in this evaluation, the adhesive composition of the present invention, which can achieve both excellent adhesion and excellent optical transparency even with a small thickness, can be used without a problem depending on the application.

TABLE 3

| | | | | Example | | | | | | |
|---|---|---|---|---|---|---|---|---|---|---|
| | | | | 1-1 | 1-2 | 1-3 | 1-4 | 1-5 | 1-6 | 1-7 |
| Adhesive | Acrylic | Type | | A | A | A | B | C | D | E |
| compo- | copolymer | (parts by mass) | | 100 | 100 | 100 | 100 | 100 | 100 | 100 |
| sition | Tackifier | Terpene phenolic resin | | 20 | — | — | 20 | — | — | — |
| | resin T1 | (available from Yasuhara Chemical | | | | | | | | |
| | (parts | Co., Ltd., “YS Polyester G150”) | | | | | | | | |
| | by mass) | Hydrogenated terpene phenolic resin | | — | 20 | — | — | 20 | 20 | 20 |
| | | (available from Yasuhara Chemical | | | | | | | | |
| | | Co., Ltd., “YS Polyester UH115”) | | | | | | | | |
| | | Xylene resin | | — | — | 20 | — | — | — | — |
| | | (available from Fudow Co., Ltd., “GHP-150”) | | | | | | | | |
| | Tackifier | Hydrocarbon resin | | — | — | — | — | — | — | — |
| | resin T2 | (available from Arakawa Chemical Industries Ltd., “ARKON P-140”) | | | | | | | | |
| | (parts | | | | | | | | | |
| | by mass) | | | | | | | | | |
| | Crosslinking | Isocyanate crosslinking agent | | 0.1 | 0.1 | 0.1 | — | 0.1 | 0.1 | 0.1 |
| | agent | (available from Tosoh Corporation, “Coronate HX”) | | | | | | | | |
| | (parts | | | | | | | | | |
| | by mass) | | | | | | | | | |
| Properties | Gel fraction of adhesive layer (% by mass) | | | 50 | 50 | 45 | 0 | 50 | 50 | 45 |
| Evaluation | Adhesion | Thickness | 180° Peeling | 15 | 12 | 14 | 9 | 14 | 13 | 13 |
| | | of | force for | | | | | | | |
| | | adhesive | glass at 23 °C | | | | | | | |
| | | layer: | of adhesive | | | | | | | |
| | | 15 μm | tape after | | | | | | | |
| | | | being attached | | | | | | | |
| | | | and then left | | | | | | | |
| | | | to stand | | | | | | | |
| | | | at 23 °C for | | | | | | | |
| | | | 24 hours | | | | | | | |
| | | | (N/inch) | | | | | | | |
| | | | Evaluation | ∘∘ | ∘∘ | ∘∘ | ∘ | ∘∘ | ∘∘ | ∘∘ |
| | | Thickness | 180° Peeling | 12 | 9 | 11 | 9 | 11 | 10 | 10 |
| | | of | force for | | | | | | | |
| | | adhesive | glass at | | | | | | | |
| | | layer: | 23 °C of | | | | | | | |
| | | 5 μm | adhesive | | | | | | | |
| | | | tape after | | | | | | | |
| | | | being | | | | | | | |
| | | | attached | | | | | | | |
| | | | and then left | | | | | | | |
| | | | to stand | | | | | | | |
| | | | at 23 °C for | | | | | | | |
| | | | 24 hours | | | | | | | |
| | | | (N/inch) | | | | | | | |
| | | | Evaluation | ∘∘ | ∘ | ∘∘ | ∘ | ∘∘ | ∘∘ | ∘∘ |
| | Optical | Haze | Haze | 0.4 | 0.2 | 0.4 | 0.4 | 0.7 | 0.7 | 0.7 |
| | transparency | (thickness of | at 23 °C (%) | | | | | | | |
| | | adhesive | Evaluation | ∘∘ | ∘∘ | ∘∘ | ∘∘ | ∘ | ∘ | ∘ |
| | | layer: | | | | | | | | |
| | | 5 μm) | | | | | | | | |
| | | Yellowness | Yellowness | 0.2 | 0.2 | 0.3 | 0.2 | 0.2 | 0.2 | 0.2 |
| | | index b* | index | | | | | | | |
| | | (thickness | b* at 23 °C | | | | | | | |
| | | of adhesive | Evaluation | ∘∘ | ∘∘ | ∘ | ∘∘ | ∘∘ | ∘∘ | ∘∘ |
| | | layer: | Yellowness | 0.4 | 0.2 | 0.4 | 0.4 | 0.2 | 0.2 | 0.2 |
| | | 15 μm) | index b* | | | | | | | |
| | | | of adhesive | | | | | | | |
| | | | tape after | | | | | | | |
| | | | being heated | | | | | | | |
| | | | at 85 °C | | | | | | | |
| | | | for | | | | | | | |
| | | | 500 hours | | | | | | | |
| | | | Evaluation | ∘ | ∘∘ | ∘ | ∘ | ∘∘ | ∘∘ | ∘∘ |

| | | | | | | | |
|---|---|---|---|---|---|---|---|
| Metal corrosivity | x | x | x | ∘ | x | ∘ | ∘ |

| | | | | Example | | | | | |
|---|---|---|---|---|---|---|---|---|---|
| | | | | 1-8 | 1-9 | 1-10 | 1-11 | 1-12 | 1-13 |
| Adhesive | Acrylic | Type | | F | G | A | A | A | A |
| compo- | copolymer | (parts by mass) | | 100 | 100 | 100 | 100 | 100 | 100 |
| sition | Tackifier | Terpene phenolic resin | | — | — | 10 | 30 | — | — |
| | resin T1 | (available from Yasuhara Chemical | | | | | | | |
| | (parts | Co., Ltd., “YS Polyester G150”) | | | | | | | |
| | by mass) | Hydrogenated terpene phenolic resin | | 20 | 20 | — | — | 45 | 30 |
| | | (available from Yasuhara Chemical | | | | | | | |
| | | Co., Ltd., “YS Polyester UH115”) | | | | | | | |
| | | Xylene resin | | — | — | — | — | — | — |
| | | (available from Fudow Co., Ltd., “GHP-150”) | | | | | | | |
| | Tackifier | Hydrocarbon resin | | — | — | — | — | — | — |
| | resin T2 | (available from Arakawa Chemical Industries Ltd., “ARKON P-140”) | | | | | | | |
| | (parts | | | | | | | | |
| | by mass) | | | | | | | | |
| | Crosslinking | Isocyanate crosslinking agent | | 0.1 | 0.1 | 0.1 | 0.1 | 0.1 | 0.1 |
| | agent | (available from Tosoh Corporation, “Coronate HX”) | | | | | | | |
| | (parts | | | | | | | | |
| | by mass) | | | | | | | | |
| Properties | Gel fraction of adhesive layer (% by mass) | | | 50 | 50 | 50 | 50 | 50 | 50 |
| Evaluation | Adhesion | Thickness | 180° Peeling | 10 | 13 | 11 | 18 | 18 | 16 |
| | | of | force for | | | | | | |
| | | adhesive | glass at 23 °C | | | | | | |
| | | layer: | of adhesive | | | | | | |
| | | 15 μm | tape after | | | | | | |
| | | | being attached | | | | | | |
| | | | and then left | | | | | | |
| | | | to stand | | | | | | |
| | | | at 23 °C for | | | | | | |
| | | | 24 hours | | | | | | |
| | | | (N/inch) | | | | | | |
| | | | Evaluation | ∘∘ | ∘∘ | ∘∘ | ∘∘ | ∘∘ | ∘∘ |
| | | Thickness | 180° Peeling | 9 | 10 | 10 | 14 | 12 | 11 |
| | | of | force for | | | | | | |
| | | adhesive | glass at | | | | | | |
| | | layer: | 23 °C of | | | | | | |
| | | 5 μm | adhesive | | | | | | |
| | | | tape after | | | | | | |
| | | | being | | | | | | |
| | | | attached | | | | | | |
| | | | and then left | | | | | | |
| | | | to stand | | | | | | |
| | | | at 23 °C for | | | | | | |
| | | | 24 hours | | | | | | |
| | | | (N/inch) | | | | | | |
| | | | Evaluation | ∘ | ∘∘ | ∘∘ | ∘∘ | ∘∘ | ∘∘ |
| | Optical | Haze | Haze | 0.7 | 0.7 | 0.3 | 0.4 | 0.2 | 0.2 |
| | transparency | (thickness of | at 23 °C (%) | | | | | | |
| | | adhesive | Evaluation | ∘ | ∘ | ∘∘ | ∘∘ | ∘∘ | ∘∘ |
| | | layer: | | | | | | | |
| | | 5 μm) | | | | | | | |
| | | Yellowness | Yellowness | 0.2 | 0.2 | 0.2 | 0.2 | 0.2 | 0.2 |
| | | index b* | index | | | | | | |
| | | (thickness | b* at 23 °C | | | | | | |
| | | of adhesive | Evaluation | ∘∘ | ∘∘ | ∘∘ | ∘∘ | ∘∘ | ∘∘ |
| | | layer: | Yellowness | 0.2 | 0.2 | 0.35 | 0.45 | 0.3 | 0.2 |
| | | 15 μm) | index b* | | | | | | |
| | | | of adhesive | | | | | | |
| | | | tape after | | | | | | |
| | | | being heated | | | | | | |
| | | | at 85 °C | | | | | | |
| | | | for | | | | | | |
| | | | 500 hours | | | | | | |
| | | | Evaluation | ∘∘ | ∘∘ | ∘ | Δ | ∘ | ∘∘ |

| | | | | | | |
|---|---|---|---|---|---|---|
| Metal corrosivity | ∘ | x | x | x | x | x |

TABLE 4

| | | | | Example | | | | | | |
|---|---|---|---|---|---|---|---|---|---|---|
| | | | | 1-14 | 1-15 | 1-16 | 1-17 | 1-18 | 1-19 | 1-20 |
| Adhesive | Acrylic copolymer | Type | | A | A | A | A | A | E | E |
| composition | | (parts by mass) | | 100 | 100 | 100 | 100 | 100 | 100 | 100 |
| | Tackifier resin T1 | Terpene phenolic resin | | — | — | — | — | 10 | — | — |
| | (parts by mass) | (available from Yasuhara Chemical | | | | | | | | |
| | | Co., Ltd., “YS Polyester G150”) | | | | | | | | |
| | | Hydrogenated terpene phenolic resin | | 10 | 5 | — | — | — | 20 | 20 |
| | | (available from Yasuhara Chemical | | | | | | | | |
| | | Co., Ltd., “YS Polyester UH115”) | | | | | | | | |
| | | Xylene resin | | — | — | 50 | 5 | 10 | — | — |
| | | (available from Fudow Co., | | | | | | | | |
| | | Ltd., “GHP-150”) | | | | | | | | |
| | Tackifier resin T2 | Hydrocarbon resin | | — | — | — | — | — | — | — |
| | (parts by mass) | (available from Arakawa Chemical | | | | | | | | |
| | | Industries Ltd., “ARKON P-140”) | | | | | | | | |
| | Crosslinking agent | Isocyanate crosslinking agent | | 0.1 | 0.1 | 0.1 | 0.1 | 0.1 | — | 0.05 |
| | (parts by mass) | (available from Tosoh Corporation, | | | | | | | | |
| | | “Coronate HX”) | | | | | | | | |
| Properties | Gel fraction of adhesive layer (% by mass) | | | 50 | 50 | 45 | 45 | 45 | 0 | 15 |
| Evaluation | Adhesion | Thickness of | 180° Peeling force for | 13 | 10 | 16 | 10 | 15 | 12 | 12 |
| | | adhesive | glass at 23 °C of adhesive | | | | | | | |
| | | layer: 15 μm | tape after being attached | | | | | | | |
| | | | and then left to stand | | | | | | | |
| | | | at 23 °C for 24 hours (N/inch) | | | | | | | |
| | | | Evaluation | ∘∘ | ∘∘ | ∘∘ | ∘∘ | ∘∘ | ∘∘ | ∘∘ |
| | | Thickness of | 180° Peeling force for glass | 10 | 9 | 13 | 9 | 12 | 9 | 9 |
| | | adhesive | at 23 °C of adhesive | | | | | | | |
| | | layer: 5 μm | tape after being attached | | | | | | | |
| | | | and then left to stand | | | | | | | |
| | | | at 23 °C for 24 hours (N/inch) | | | | | | | |
| | | | Evaluation | ∘∘ | ∘ | ∘∘ | ∘ | ∘∘ | ∘ | ∘ |
| | Optical transparency | Haze (thickness of | Haze at 23 °C (%) | 0.2 | 0.2 | 0.6 | 0.4 | 0.4 | 0.7 | 0.7 |
| | | adhesive | Evaluation | ∘∘ | ∘∘ | ∘ | ∘∘ | ∘∘ | ∘ | ∘ |
| | | layer: 5 μm) | | | | | | | | |
| | | Yellowness index b* | Yellowness | 0.2 | 0.2 | 0.5 | 0.2 | 0.2 | 0.2 | 0.2 |
| | | (thickness of ) | index b* at 23 °C | | | | | | | |
| | | adhesive | Evaluation | ∘∘ | ∘∘ | ∘ | ∘∘ | ∘∘ | ∘∘ | ∘∘ |
| | | layer: 15 μm | Yellowness index b* of | 0.2 | 0.2 | 0.5 | 0.2 | 0.3 | 0.2 | 0.2 |
| | | | adhesive tape after | | | | | | | |
| | | | being heated at 85 °C | | | | | | | |
| | | | for 500 hours | | | | | | | |
| | | | Evaluation | ∘∘ | ∘∘ | ΔΔ | ∘∘ | ∘ | ∘∘ | ∘∘ |

| | | | | | | | |
|---|---|---|---|---|---|---|---|
| Metal corrosivity | x | x | x | x | x | ∘ | ∘ |

| | | | | Example | | | | | | | |
|---|---|---|---|---|---|---|---|---|---|---|---|
| | | | | 1-21 | 1-22 | 1-23 | 1-24 | 1-25 | 1-26 | 1-27 | 1-28 |
| Adhesive | Acrylic copolymer | Type | | E | E | A | A | A | H | I | A |
| composition | | (parts by mass) | | 100 | 100 | 100 | 100 | 100 | 100 | 100 | 100 |
| | Tackifier resin T1 | Terpene phenolic resin | | — | — | 20 | 20 | 5 | 20 | 20 | 10 |
| | (parts by mass) | (available from Yasuhara Chemical | | | | | | | | | |
| | | Co., Ltd., “YS Polyester G150”) | | | | | | | | | |
| | | Hydrogenated terpene phenolic resin | | 20 | 20 | — | — | — | — | — | — |
| | | (available from Yasuhara Chemical | | | | | | | | | |
| | | Co., Ltd., “YS Polyester UH115”) | | | | | | | | | |
| | | Xylene resin | | — | — | — | — | — | — | — | — |
| | | (available from Fudow Co., | | | | | | | | | |
| | | Ltd., “GHP-150”) | | | | | | | | | |
| | Tackifier resin T2 | Hydrocarbon resin | | — | — | 5 | 10 | 10 | — | — | — |
| | (parts by mass) | (available from Arakawa Chemical | | | | | | | | | |
| | | Industries Ltd., “ARKON P-140”) | | | | | | | | | |
| | Crosslinking agent | Isocyanate crosslinking agent | | 0.2 | 0.25 | 0.1 | 0.1 | 0.1 | 0.1 | 0.1 | 0.1 |
| | (parts by mass) | (available from Tosoh Corporation, | | | | | | | | | |
| | | “Coronate HX”) | | | | | | | | | |
| Properties | Gel fraction of adhesive layer (% by mass) | | | 75 | 85 | 40 | 50 | 50 | 50 | 50 | 50 |
| Evaluation | Adhesion | Thickness of | 180° Peeling force for | 12 | 9 | 13 | 12 | 9 | 13 | 15 | 13 |
| | | adhesive | glass at 23 °C of adhesive | | | | | | | | |
| | | layer: 15 μm | tape after being attached | | | | | | | | |
| | | | and then left to stand | | | | | | | | |
| | | | at 23 °C for 24 hours (N/inch) | | | | | | | | |
| | | | Evaluation | ∘∘ | ∘ | ∘∘ | ∘∘ | ∘ | ∘∘ | ∘∘ | ∘∘ |
| | | Thickness of | 180° Peeling force for glass | 9 | 9 | 11 | 10 | 9 | 10 | 13 | 11 |
| | | adhesive | at 23 °C of adhesive | | | | | | | | |
| | | layer: 5 μm | tape after being attached | | | | | | | | |
| | | | and then left to stand | | | | | | | | |
| | | | at 23 °C for 24 hours (N/inch) | | | | | | | | |
| | | | Evaluation | ∘ | ∘ | ∘∘ | ∘∘ | ∘ | ∘∘ | ∘∘ | ∘∘ |
| | Optical transparency | Haze (thickness of | Haze at 23 °C (%) | 0.7 | 0.7 | 1.2 | 1.5 | 1.5 | 0.4 | 0.4 | 0.4 |
| | | adhesive | Evaluation | ∘ | ∘ | Δ | Δ | Δ | ∘∘ | ∘∘ | ∘∘ |
| | | layer: 5 μm) | | | | | | | | | |
| | | Yellowness index b* | Yellowness | 0.2 | 0.2 | 0.2 | 0.2 | 0.2 | 0.2 | 0.2 | 0.2 |
| | | (thickness of ) | index b* at 23 °C | | | | | | | | |
| | | adhesive | Evaluation | ∘∘ | ∘∘ | ∘∘ | ∘∘ | ∘∘ | ∘∘ | ∘∘ | ∘∘ |
| | | layer: 15 μm | Yellowness index b* of | 0.2 | 0.2 | 0.4 | 0.4 | 0.3 | 0.4 | 0.4 | 0.4 |
| | | | adhesive tape after | | | | | | | | |
| | | | being heated at 85 °C | | | | | | | | |
| | | | for 500 hours | | | | | | | | |
| | | | Evaluation | ∘∘ | ∘∘ | ∘ | ∘ | ∘ | ∘ | ∘ | ∘ |

| | | | | | | | | |
|---|---|---|---|---|---|---|---|---|
| Metal corrosivity | ∘ | ∘ | x | x | x | x | x | x |

TABLE 5

| | | | | Example | | | | |
|---|---|---|---|---|---|---|---|---|
| | | | | 2-1 | 2-2 | 2-3 | 2-4 | 2-5 |
| Adhesive | Acrylic copolymer | Type | | A | J | K | L | C |
| composition | | (parts by mass) | | 100 | 100 | 100 | 100 | 100 |
| | Tackifier resin T1 | Terpene phenolic resin | | — | — | — | — | — |
| | (parts by mass) | (available from Yasuhara Chemical | | | | | | |
| | | Co., Ltd., “YS Polyester G150”) | | | | | | |
| | | Hydrogenated resin (available | | — | — | — | — | — |
| | | from Arakawa Chemical Industries | | | | | | |
| | | Ltd., “ARKON P-140”) | | | | | | |
| | Crosslinking agent | Isocyanate crosslinking agent | | 0.1 | 0.1 | 0.1 | 0.1 | 0.1 |
| | (parts by mass) | (available from Tosoh Corporation, | | | | | | |
| | | “Coronate HX”) | | | | | | |
| Properties | Gel fraction of adhesive layer (% by mass) | | | 50 | 50 | 50 | 50 | 50 |
| Evaluation | Adhesion | Thickness of | 180° Peeling force for | 9 | 9 | 10 | 11 | 12 |
| | | adhesive layer: | glass at 23 °C of | | | | | |
| | | 15 μm | adhesive tape after | | | | | |
| | | | being attached and | | | | | |
| | | | then left to stand at | | | | | |
| | | | 23 °C for 24 hours (N/inch) | | | | | |
| | | | Evaluation | ∘ | ∘ | ∘∘ | ∘∘ | ∘∘ |
| | | Thickness of | 180° Peeling force for | 8 | 8 | 8 | 9 | 10 |
| | | adhesive layer: | glass at 23 °C of | | | | | |
| | | 5 μm | adhesive tape after | | | | | |
| | | | being attached and | | | | | |
| | | | then left to stand at | | | | | |
| | | | 23 °C for 24 hours (N/inch) | | | | | |
| | | | Evaluation | Δ | Δ | Δ | ∘ | ∘∘ |
| | Optical transparency | Haze (thickness of | Haze at 23 °C (%) | 0.2 | 0.2 | 0.2 | 0.4 | 0.6 |
| | | adhesive layer: 5 μm) | Evaluation | ∘∘ | ∘∘ | ∘∘ | ∘∘ | ∘ |
| | | Yellowness index b* | Yellowness index b* at 23 °C | 0.2 | 0.2 | 0.2 | 0.2 | 0.2 |
| | | (thickness of | Evaluation | ∘∘ | ∘∘ | ∘∘ | ∘∘ | ∘∘ |
| | | adhesive layer: 15 μm) | Yellowness index b* | 0.2 | 0.2 | 0.2 | 0.2 | 0.2 |
| | | | of adhesive tape after | | | | | |
| | | | being heated at 85 °C for 500 hours | | | | | |
| | | | Evaluation | ∘∘ | ∘∘ | ∘∘ | ∘∘ | ∘∘ |

| | | | | | |
|---|---|---|---|---|---|
| Metal corrosivity | x | ∘ | x | x | x |

| | | | | Example | | | |
|---|---|---|---|---|---|---|---|
| | | | | 2-6 | 2-7 | 2-8 | 2-9 |
| Adhesive | Acrylic copolymer | Type | | E | M | N | O |
| composition | | (parts by mass) | | 100 | 100 | 100 | 100 |
| | Tackifier resin T1 | Terpene phenolic resin | | — | — | — | — |
| | (parts by mass) | (available from Yasuhara Chemical | | | | | |
| | | Co., Ltd., “YS Polyester G150”) | | | | | |
| | | Hydrogenated resin (available | | — | — | — | — |
| | | from Arakawa Chemical Industries | | | | | |
| | | Ltd., “ARKON P-140”) | | | | | |
| | Crosslinking agent | Isocyanate crosslinking agent | | 0.1 | 0.1 | 0.1 | 0.1 |
| | (parts by mass) | (available from Tosoh Corporation, | | | | | |
| | | “Coronate HX”) | | | | | |
| Properties | Gel fraction of adhesive layer (% by mass) | | | 50 | 50 | 50 | 45 |
| Evaluation | Adhesion | Thickness of | 180° Peeling force for | 12 | 13 | 10 | 10 |
| | | adhesive layer: | glass at 23 °C of | | | | |
| | | 15 μm | adhesive tape after | | | | |
| | | | being attached and | | | | |
| | | | then left to stand at | | | | |
| | | | 23 °C for 24 hours (N/inch) | | | | |
| | | | Evaluation | ∘∘ | ∘∘ | ∘∘ | ∘∘ |
| | | Thickness of | 180° Peeling force for | 9 | 10 | 8 | 8 |
| | | adhesive layer: | glass at 23 °C of | | | | |
| | | 5 μm | adhesive tape after | | | | |
| | | | being attached and | | | | |
| | | | then left to stand at | | | | |
| | | | 23 °C for 24 hours (N/inch) | | | | |
| | | | Evaluation | ∘ | ∘∘ | Δ | Δ |
| | Optical transparency | Haze (thickness of | Haze at 23 °C (%) | 0.6 | 0.7 | 0.7 | 0.5 |
| | | adhesive layer: 5 μm) | Evaluation | ∘ | ∘ | ∘ | ∘∘ |
| | | Yellowness index b* | Yellowness index b* at 23 °C | 0.2 | 0.2 | 0.2 | 0.2 |
| | | (thickness of | Evaluation | ∘∘ | ∘∘ | ∘∘ | ∘∘ |
| | | adhesive layer: 15 μm) | Yellowness index b* | 0.2 | 0.2 | 0.2 | 0.2 |
| | | | of adhesive tape after | | | | |
| | | | being heated at 85 °C for 500 hours | | | | |
| | | | Evaluation | ∘∘ | ∘∘ | ∘∘ | ∘∘ |

| | | | | |
|---|---|---|---|---|
| Metal corrosivity | ∘ | ∘ | ∘ | ∘ |

TABLE 6

| | | | | Example | | | | |
|---|---|---|---|---|---|---|---|---|
| | | | | 2-10 | 2-11 | 2-12 | 2-13 | 2-14 |
| Adhesive | Acrylic copolymer | Type | | P | I | H | E | E |
| composition | | (parts by mass) | | 100 | 100 | 100 | 100 | 100 |
| | Tackifier resin T1 | Terpene phenolic resin | | — | — | — | — | — |
| | (parts by mass) | (available from Yasuhara Chemical | | | | | | |
| | | Co., Ltd., “YS Polyester G150”) | | | | | | |
| | | Hydrocarbon resin | | — | — | — | — | — |
| | | (available from Arakawa Chemical | | | | | | |
| | | Industries Ltd., “ARKON P-140”) | | | | | | |
| | Crosslinking agent | Isocyanate crosslinking agent | | 0.1 | 0.1 | 0.1 | — | 0.05 |
| | (parts by mass) | (available from Tosoh Corporation, | | | | | | |
| | | “Coronate HX”) | | | | | | |
| Properties | Gel fraction of adhesive layer (% by mass) | | | 45 | 45 | 45 | 0 | 15 |
| Evaluation | Adhesion | Thickness of adhesive layer: 15 μm | 180° Peeling force for | 11 | 8 | 10 | 12 | 12 |
| | | | glass at 23 °C of adhesive | | | | | |
| | | | tape after being attached | | | | | |
| | | | and then left to stand | | | | | |
| | | | at 23 °C for 24 hours (N/inch) | | | | | |
| | | | Evaluation | ∘∘ | Δ | ∘∘ | ∘∘ | ∘∘ |
| | | Thickness of adhesive layer: 5 μm | 180° Peeling force for glass | 9 | 8 | 9 | 9 | 9 |
| | | | at 23 °C of adhesive | | | | | |
| | | | tape after being attached | | | | | |
| | | | and then left to stand | | | | | |
| | | | at 23 °C for 24 hours (N/inch) | | | | | |
| | | | Evaluation | ∘ | Δ | ∘ | ∘ | ∘ |
| | Optical transparency | Haze (thickness of | Haze at 23 °C (%) | 0.4 | 0.2 | 0.2 | 0.6 | 0.6 |
| | | adhesive layer: 5 μm) | Evaluation | ∘∘ | ∘∘ | ∘∘ | ∘ | ∘ |
| | | Yellowness index b* | Yellowness index b* at 23 C | 0.2 | 0.2 | 0.2 | 0.2 | 0.2 |
| | | (thickness of | Evaluation | ∘∘ | ∘∘ | ∘∘ | ∘∘ | ∘∘ |
| | | adhesive layer: 15 μm) | Yellowness index b* of | 0.2 | 0.2 | 0.2 | 0.2 | 0.2 |
| | | | adhesive tape after | | | | | |
| | | | being heated at 85 °C | | | | | |
| | | | for 500 hours | | | | | |
| | | | Evaluation | ∘∘ | ∘∘ | ∘∘ | ∘∘ | ∘∘ |

| | | | | | |
|---|---|---|---|---|---|
| Metal corrosivity | ∘ | x | x | ∘ | ∘ |

| | | | | Example | | | | |
|---|---|---|---|---|---|---|---|---|
| | | | | 2-15 | 2-16 | 2-17 | 2-18 | 2-19 |
| Adhesive | Acrylic copolymer | Type | | E | E | A | A | A |
| composition | | (parts by mass) | | 100 | 100 | 100 | 100 | 100 |
| | Tackifier resin T1 | Terpene phenolic resin | | — | — | 2 | 5 | — |
| | (parts by mass) | (available from Yasuhara Chemical | | | | | | |
| | | Co., Ltd., “YS Polyester G150”) | | | | | | |
| | | Hydrocarbon resin | | — | — | — | — | — |
| | | (available from Arakawa Chemical | | | | | | |
| | | Industries Ltd., “ARKON P-140”) | | | | | | |
| | Crosslinking agent | Isocyanate crosslinking agent | | 0.17 | 0.2 | 0.1 | 0.1 | 0.1 |
| | (parts by mass) | (available from Tosoh Corporation, | | | | | | |
| | | “Coronate HX”) | | | | | | |
| Properties | Gel fraction of adhesive layer (% by mass) | | | 76 | 85 | 50 | 50 | 50 |
| Evaluation | Adhesion | Thickness of adhesive layer: 15 μm | 180° Peeling force for | 10 | 9 | 9 | 11 | 9 |
| | | | glass at 23 °C of adhesive | | | | | |
| | | | tape after being attached | | | | | |
| | | | and then left to stand | | | | | |
| | | | at 23 °C for 24 hours (N/inch) | | | | | |
| | | | Evaluation | ∘∘ | ∘ | ∘ | ∘∘ | ∘ |
| | | Thickness of adhesive layer: 5 μm | 180° Peeling force for glass | 9 | 8 | 8 | 10 | 8 |
| | | | at 23 °C of adhesive | | | | | |
| | | | tape after being attached | | | | | |
| | | | and then left to stand | | | | | |
| | | | at 23 °C for 24 hours (N/inch) | | | | | |
| | | | Evaluation | ∘ | Δ | Δ | ∘∘ | Δ |
| | Optical transparency | Haze (thickness of | Haze at 23 °C (%) | 0.6 | 0.6 | 0.3 | 0.3 | 0.2 |
| | | adhesive layer: 5 μm) | Evaluation | ∘ | ∘ | ∘ | ∘∘ | ∘∘ |
| | | Yellowness index b* | Yellowness index b* at 23 C | 0.2 | 0.2 | 0.2 | 0.2 | 0.2 |
| | | (thickness of | Evaluation | ∘∘ | ∘∘ | ∘∘ | ∘∘ | ∘∘ |
| | | adhesive layer: 15 μm) | Yellowness index b* of | 0.2 | 0.2 | 0.2 | 0.2 | 0.2 |
| | | | adhesive tape after | | | | | |
| | | | being heated at 85 °C | | | | | |
| | | | for 500 hours | | | | | |
| | | | Evaluation | ∘∘ | ∘∘ | ∘∘ | ∘∘ | ∘∘ |

| | | | | | |
|---|---|---|---|---|---|
| Metal corrosivity | ∘ | ∘ | x | x | x |

TABLE 7

| | | | | Comparative Example | | | |
|---|---|---|---|---|---|---|---|
| | | | | 1 | 2 | 3 | 4 |
| Adhesive | Acrylic copolymer | Type | | A | A | A | Q |
| composition | | (parts by mass) | | 100 | 100 | 100 | 100 |
| | Tackifier resin T1 | Terpene phenolic resin | | — | — | 20 | 20 |
| | (parts by mass) | (available from Yasuhara Chemical Co., | | | | | |
| | | Ltd., “YS Polyester G150”) | | | | | |
| | | Hydrogenated terpene phenolic resin | | 55 | — | — | — |
| | | (available from Yasuhara Chemical Co., | | | | | |
| | | Ltd., “YS Polyester UH115”) | | | | | |
| | | Xylene resin | | — | — | — | — |
| | | (available from Fudow Co., | | | | | |
| | | Ltd., “GHP-150”) | | | | | |
| | Tackifier resin T2 | Hydrocarbon resin | | — | 15 | 15 | — |
| | (parts by mass) | (available from Arakawa Chemical | | | | | |
| | | Industries Ltd., “ARKON P-140”) | | | | | |
| | Crosslinking agent | Isocyanate crosslinking agent | | 0.1 | 0.1 | 0.1 | 0.1 |
| | (parts by mass) | (available from Tosoh Corporation, | | | | | |
| | | “Coronate HX”) | | | | | |
| Properties | Gel fraction of adhesive layer (% by mass) | | | 50 | 50 | 40 | 40 |
| Evaluation | Adhesion | Thickness of adhesive layer: 15 μm | 180° Peeling force for glass | 1 | 8 | 15 | 8 |
| | | | at 23 °C of adhesive | | | | |
| | | | tape after being attached | | | | |
| | | | and then left to stand | | | | |
| | | | at 23 °C for 24 hours (N/inch) | | | | |
| | | | Evaluation | x | Δ | ∘∘ | Δ |
| | | Thickness of adhesive layer: 5 °m | 180° Peeling force for glass | 1 | 7 | 10 | 7 |
| | | | at 23 °C of adhesive | | | | |
| | | | tape after being attached | | | | |
| | | | and then left to stand | | | | |
| | | | at 23 °C for 24 hours (N/inch) | | | | |
| | | | Evaluation | x | x | ∘∘ | x |
| | Optical transparency | Haze (thickness of | Haze at 23 °C (%) | 0.2 | 3 | 3 | 0.3 |
| | | adhesive layer: 5 °m) | Evaluation | ∘∘ | x | x | ∘∘ |
| | | Yellowness index b* | Yellowness index b* at 23 °C | 0.2 | 0.2 | 0.3 | 0.2 |
| | | (thickness of | Evaluation | ∘∘ | ∘∘ | ∘ | ∘∘ |
| | | adhesive layer: 15 °m) | Yellowness index b* of | 0.35 | 0.2 | 0.4 | 0.2 |
| | | | adhesive tape after | | | | |
| | | | being heated at 85 °C | | | | |
| | | | for 500 hours | | | | |
| | | | Evaluation | ∘ | ∘∘ | ∘ | ∘∘ |

| | | | | |
|---|---|---|---|---|
| Metal corrosivity | x | x | x | x |

TABLE 8

| | | | | Comparative Example | | | | |
|---|---|---|---|---|---|---|---|---|
| | | | | 5 | 6 | 7 | 8 | 9 |
| Adhesive | Acrylic copolymer | Type | | B | Q | R | S | A |
| composition | | (parts by mass) | | 100 | 100 | 100 | 100 | 100 |
| | Tackifier resin T1 | Terpene phenolic resin | | — | — | — | — | — |
| | (parts by mass) | (available from Yasuhara Chemical | | | | | | |
| | | Co., Ltd., “YS Polyester G150”) | | | | | | |
| | | Hydrogenated terpene phenolic resin | | — | — | — | — | 10 |
| | | (available from Yasuhara Chemical | | | | | | |
| | | Co., Ltd., “YS Polyester G150”) | | | | | | |
| | Crosslinking agent | Isocyanate crosslinking agent | | — | 0.1 | 0.1 | 0.1 | 0.1 |
| | (parts by mass) | (available from Tosoh Corporation, | | | | | | |
| | | “Coronate HX”) | | | | | | |
| Properties | Gel fraction of adhesive layer (% by mass) | | | 0 | 40 | 40 | 40 | 50 |
| Evaluation | Adhesion | Thickness of adhesive layer: 15 μm | 180° Peeling force for glass | 8 | 8 | 8 | 4 | 6 |
| | | | at 23 °C of adhesive | | | | | |
| | | | tape after being attached | | | | | |
| | | | and then left to stand | | | | | |
| | | | at 23 °C for 24 hours (N/inch) | | | | | |
| | | | Evaluation | Δ | Δ | Δ | x | x |
| | | Thickness of adhesive layer: 5 μm | 180° Peeling force for glass | 6 | 6 | 6 | 3 | 5 |
| | | | at 23 °C of adhesive | | | | | |
| | | | tape after being attached | | | | | |
| | | | and then left to stand | | | | | |
| | | | at 23 °C for 24 hours (N/inch) | | | | | |
| | | | Evaluation | x | x | x | x | x |
| | Optical transparency | Haze (thickness of | Haze at 23 °C (%) | 0.2 | 0.7 | 0.2 | 0.2 | 2.5 |
| | | adhesive layer: 5 μm) | Evaluation | ∘∘ | ∘ | ∘∘ | ∘∘ | x |
| | | Yellowness index b* | Yellowness index b* at 23 °C | 0.2 | 0.2 | 0.2 | 0.2 | 0.2 |
| | | (thickness of | Evaluation | ∘∘ | ∘∘ | ∘∘ | ∘∘ | ∘∘ |
| | | adhesive layer: 15 μm) | Yellowness index b* | 0.2 | 0.2 | 0.2 | 0.2 | 0.2 |
| | | | of adhesive tape | | | | | |
| | | | after being heated | | | | | |
| | | | at 85 °C for 500 hours | | | | | |
| | | | Evaluation | ∘∘ | ∘∘ | ∘∘ | ∘∘ | ∘∘ |

| | | | | | |
|---|---|---|---|---|---|
| Metal corrosivity | ∘ | ∘ | ∘ | x | x |

### INDUSTRIAL APPLICABILITY

The present invention can provide an adhesive composition that can achieve both excellent adhesion and excellent optical transparency even when thinly applied. The present invention can also provide an adhesive tape including an adhesive layer containing the adhesive composition.

1. An adhesive composition comprising an acrylic copolymer containing a structural unit derived from an alkyl (meth)acrylate and a structural unit derived from an olefinic polymer having a polymerizable unsaturated double bond at an end,
the adhesive composition satisfying at least one structure selected from the group consisting of the following first structure and the following second structure:
first structure: the adhesive composition contains at least one tackifier resin T1 selected from the group consisting of a terpene phenolic resin, a hydrogenated terpene phenolic resin, and a xylene resin,
the tackifier resin T1 is contained in an amount of 5 parts by mass or more and 50 parts by mass or less relative to 100 parts by mass of the acrylic copolymer, and
the adhesive composition does not contain a tackifier resin T2 different from a terpene phenolic resin, a hydrogenated terpene phenolic resin, and a xylene resin or contains the tackifier resin T2, and when the adhesive composition contains the tackifier resin T2, the tackifier resin T2 is contained in an amount of 10 parts by mass or less relative to 100 parts by mass of the acrylic copolymer; and
second structure: the acrylic copolymer contains a structural unit derived from a monomer containing a polar functional group,
the acrylic copolymer contains a structural unit derived from an alkyl (meth)acrylate in which an alkyl group bound to an oxygen atom of an ester bond has a carbon number of 1 to 4,
the structural unit derived from an alkyl (meth)acrylate in which an alkyl group bound to an oxygen atom of an ester bond has a carbon number of 1 to 4 is contained in an amount of 30% by mass or more and 90% by mass or less in the acrylic copolymer, and
the adhesive composition contains no tackifier resin or contains a tackifier resin, and when the adhesive composition contains a tackifier resin, the tackifier resin is contained in an amount of 5 parts by mass or less relative to 100 parts by mass of the acrylic copolymer.

2. The adhesive composition according to claim 1,
wherein in the first structure, the acrylic copolymer contains a structural unit derived from a monomer containing a polar functional group.

3. The adhesive composition according to claim 1,
wherein the structural unit derived from a monomer containing a polar functional group comprises at least one structural unit selected from the group consisting of a structural unit derived from a carboxy group-containing monomer and a structural unit derived from a hydroxy group-containing monomer.

4. The adhesive composition according to claim 3,
wherein the structural unit derived from a monomer containing a polar functional group comprises the structural unit derived from a carboxy group-containing monomer.

5. The adhesive composition according to claim 4,
wherein in the second structure, the structural unit derived from a carboxy group-containing monomer is contained in an amount of 10% by mass or less in the acrylic copolymer.

6. The adhesive composition according to claim 4,
wherein the structural unit derived from a carboxy group-containing monomer is contained in an amount of 1% by mass or less in the acrylic copolymer.

7. The adhesive composition according to claim 3,
wherein the structural unit derived from a monomer containing a polar functional group comprises the structural unit derived from a hydroxy group-containing monomer.

8. The adhesive composition according to claim 1,
wherein in the first structure, the tackifier resin T1 comprises the hydrogenated terpene phenolic resin.

9. The adhesive composition according to claim 1,
wherein in the second structure, the acrylic copolymer contains a structural unit derived from an alkyl (meth)acrylate in which an alkyl group bound to an oxygen atom of an ester bond has a carbon number of 1 to 2, and
the structural unit derived from an alkyl (meth)acrylate in which an alkyl group bound to an oxygen atom of an ester bond has a carbon number of 1 to 2 is contained in an amount of 10% by mass or more and 60% by mass or less in the acrylic copolymer.

10. The adhesive composition according to claim 1,
wherein in the second structure, the acrylic copolymer contains a structural unit derived from an alkyl (meth)acrylate in which an alkyl group bound to an oxygen atom of an ester bond has a carbon number of 3 to 4, and
the structural unit derived from an alkyl (meth)acrylate in which an alkyl group bound to an oxygen atom of an ester bond has a carbon number of 3 to 4 is contained in an amount of 60% by mass or more in the acrylic copolymer.

11. An adhesive tape comprising an adhesive layer containing the adhesive composition according to claim 1.

12. The adhesive tape according to claim 11,
wherein the adhesive layer has a gel fraction of 10% by mass or more and 80% by mass or less.

13. The adhesive tape according to claim 11,
wherein the adhesive layer has a thickness of 15 μm or less.

14. The adhesive tape according to claim 13, which has a 180° peeling force for glass at 23 °C of 9 N/inch or higher after being attached and then left to stand at 23 °C for 24 hours.

15. The adhesive tape according to claim 11, which has a haze at 23 °C of 1.0% or lower.

16. The adhesive tape according to claim 11, which includes no substrate.
